(19) United States
(12) Patent Application Publication
(10) Pub. No.: US 2026/0112657 A1
(43) Pub. Date: Apr. 23, 2026

(54) METHOD FOR RECOVERING LITHIUM FROM WASTE PRIMARY LITHIUM BATTERY LEACHATE AND PRODUCING LITHIUM CHLORIDE THEREFROM

(71) Applicant: Korea Institute Of Geoscience And Mineral Resources, Daejeon (KR)

(72) Inventors: Tae-Gong RYU, Daejeon (KR); Jun-Ho SHIN, Daejeon (KR); Jae-Min JEONG, Daejeon (KR)

(73) Assignee: Korea Institute Of Geoscience And Mineral Resources, Daejeon (KR)

(21) Appl. No.: 19/146,143

(22) PCT Filed: Jan. 4, 2024
(86) PCT No.: PCT/KR2024/000227

§ 371 Date: Jul. 7, 2025

(30) Foreign Application Priority Data
Jan. 6, 2023 (KR) 10-2023-0002064

(51) Int. Cl. H01M 6/52; C01D 15/04; C22B 1/06; C22B 7/00; C22B 26/12

(52) U.S. Cl. CPC H01M 6/52; C01D 15/04; C22B 1/06; C22B 7/006; C22B 26/12

(57) ABSTRACT

The present invention provides a method for recovering lithium from a waste primary lithium battery leachate and producing lithium chloride therefrom, wherein a lithium component is separated as a precipitated and insoluble lithium compound, which is then converted into a lithium chloride solution through wet conversion, followed by crystallization, thereby preparing a lithium chloride powder.

### TECHNICAL FIELD

The present disclosure relates to a method for recovering lithium from a leachate of a wasted primary lithium battery and producing lithium chloride therefrom. In particular, the present disclosure relates to a method for recovering lithium from a leachate of a wasted primary lithium battery by separating lithium components through precipitation and formation of an insoluble lithium compound, converting the separated compound into a lithium chloride solution through a wet conversion reaction, and crystallizing the solution to produce lithium chloride powder.

### BACKGROUND ART

Primary lithium batteries are widely used in applications requiring long life for low or medium current discharge, such as memory backup, electricity meters, water meters, gas meters, heat meters, sensors, and military equipment. However, these batteries are discarded after a certain period of use due to their replacement cycle, and to date, they have been disposed of without economic recycling technologies.

Accordingly, it is desirable to convert the lithium in the leachate generated after discharging and leaching the batteries into lithium chloride via a wet conversion process to utilize this as a raw material for lithium metal production.

In addition, the leachate generated after discharging and leaching the batteries contains a high-grade lithium resource with a concentration of about 0.5% to 1%. Therefore, there is a need to provide a method for efficiently separating lithium components from the leachate.

Conventional methods for producing lithium compounds, such as evaporation and concentration, are not suitable for such leachates. Instead, non-evaporative lithium recovery techniques such as precipitation, solvent extraction, and adsorption are considered more appropriate.

However, precipitation and solvent extraction methods generally exhibit low selectivity for lithium ions and require prior removal of impurity ions in the solution.

This is because divalent or trivalent metal ions present with lithium ions react more readily with precipitants or extractants, resulting in excessive consumption of these reagents and low lithium recovery yields in proportion to the content of divalent or trivalent metal ions. In particular, the relative content of insoluble lithium compounds recovered by precipitation is low.

The insoluble lithium compounds that can be recovered include lithium phosphate (Li₃PO₄) and Li—Al layered double hydroxide (LiAl₂(OH)₇·2H₂O), which are typically obtained using phosphate or aluminum compounds as precipitants.

The recovery efficiency of lithium via precipitation depends on the solubility of the resulting lithium compound and the lithium concentration in the solution. Since Li—Al LDH(LiAl₂(OH)₇2H₂O) has lower solubility than lithium phosphate (Li₃PO₄), it is more suitable for use with low-concentration lithium solutions (<1000 ppm) from which divalent or trivalent metal ions have been removed.

However, for converting Li—Al LDH(LiAl₂(OH)₇·2H₂O) into lithium chloride solution, its low lithium content requires repeated leaching and conversion steps, which lowers the process efficiency.

Adsorption methods are generally applied to recover low-concentration lithium ions using Li—Mn—O-based adsorbents (e.g., Li_{1.33}Mn_{1.67}O₄, LiMn₂O₄, Li_{1.6}Mn_{1.6}O₄), which exhibit selective affinity for lithium ions. In such adsorption processes, the lithium content in the Li—Mn—O adsorbent is first replaced with hydrogen ions by reacting the adsorbent with an acid solution, thereby activating the material for lithium uptake.

Subsequently, to recover the adsorbed lithium ions, the adsorbent is treated again with an acid solution, which facilitates H—Li ion exchange (desorption). During desorption, a controlled solid-to-liquid ratio and repeated adsorption/desorption cycles are employed to obtain a lithium-containing solution with a lithium ion concentration of approximately 1500 ppm. However, the adsorption efficiency is significantly hindered when applied to lithium-containing waste solutions with low pH. Therefore, when using adsorption methods for lithium recovery from such acidic leachates, it is necessary to adjust the pH of the solution to an alkaline range, which adds process complexity and operational burden.

To address the aforementioned problems, the inventors of the present disclosure have made extensive efforts and conducted various studies to develop the present disclosure.

Specifically, by considering the composition and concentration of lithium in the solution, a precipitation method was applied to separate lithium as an insoluble lithium compound. The separated compound was then converted into a lithium chloride solution through a wet conversion reaction, and subsequently crystallized to produce lithium chloride powder.

Furthermore, lithium recovery efficiency during the separation and conversion process from the leachate was evaluated, and optimized conditions were established to suppress impurity incorporation, thereby completing the present disclosure.

### DISCLOSURE

### Technical Problem

Therefore, a purpose of the present disclosure is to provide a method for recovering lithium in a concentration of 0.5% to 1% contained in a waste lithium primary battery leachate. The lithium can be recovered from the waste lithium primary battery leachate by purifying impurities from the waste lithium primary battery leachate to form a lithium-purified solution and recovering lithium components from the lithium-purified solution as an insoluble lithium compound.

In addition, another purpose of the present disclosure is to provide a method for producing lithium chloride from a waste lithium primary battery leachate, wherein the insoluble lithium compound is converted into a lithium chloride solution through a wet conversion reaction, and the lithium chloride solution is crystallized to produce lithium chloride having a purity of 95% or higher.

The problems to be solved by the present disclosure are not limited to those mentioned above, and other issues not explicitly stated will be clearly understood by those skilled in the art from the following description.

### Technical Solution

In order to achieve the purpose, an aspect of the present disclosure provides a method for recovering lithium from waste primary lithium battery leachate and producing lithium chloride therefrom, comprising the steps of: (1) preparing a lithium purification solution by separating impurities from a leachate of a waste primary lithium battery; (2) separating an insoluble lithium compound, which is lithium phosphate (Li₃PO₄) or lithium carbonate (Li₂CO₃), from the lithium purification solution; (3) converting the insoluble lithium compound into a lithium chloride solution; and (4) producing lithium chloride powder from the lithium chloride solution.

In some exemplary embodiments, in step (1), the leachate of the waste primary lithium battery may comprise at least one selected from the group consisting of lithium (Li), nickel (Ni), aluminum (Al), magnesium (Mg), calcium (Ca), cobalt (Co), manganese (Mn), silicon (Si), copper (Cu), vanadium (V), sodium (Na), potassium (K), chromium (Cr), iron (Fe), and zinc (Zn).

In some exemplary embodiments, in step (1), the impurities may be separated from the leachate of the waste primary lithium battery by a pH adjustment method or a co-precipitation method.

In some exemplary embodiments, the pH adjustment method may be performed using an alkaline solution, the alkaline solution comprising at least one selected from the group consisting of sodium hydroxide (NaOH), potassium hydroxide (KOH), sodium carbonate (Na₂CO₃), sodium bicarbonate (NaHCO₃), potassium carbonate (K₂CO₃), and potassium bicarbonate (KHCO₃), and a range of the pH may be from 3 to 11.

In some exemplary embodiments, the co-precipitation method may be performed using a co-precipitant, the co-precipitant may be calcium oxide (CaO) or calcium hydroxide (Ca(OH)₂), and a molar ratio of metal ions in the co-precipitant to the impurities (Al+Cr+Fe) may be from 0.5 to 2.

In some exemplary embodiments, in step (2), the insoluble lithium compound separated from the lithium purification solution may be lithium carbonate or lithium phosphate.

In some exemplary embodiments, the lithium carbonate may be obtained by a carbonation reaction,
the carbonation reaction may further include a step of adjusting pH,
a range of the pH may be from 7 to 12,
a molar ratio of lithium to carbonate (Li/CO₃) may be from 1 to 2.5, and
a temperature of the carbonation reaction may be from 50° C. to 100° C.

In some exemplary embodiments, the lithium phosphate may be obtained by a precipitation method using a precipitant,
the precipitant may be at least one selected from the group consisting of phosphoric acid (H₃PO₄), sodium phosphate (Na₃PO₄), and ammonium phosphate ((NH₄)₂HPO₄),
sodium hydroxide (NaOH) may be mixed with the precipitant to adjust pH,
a range of the pH may be from 8 to 14,
a molar ratio of lithium to phosphate (Li/PO₄) may be from 2 to 6, and
a molar ratio of sodium to phosphate (Na/PO₄) may be from 2 to 5.

In some exemplary embodiments, the method may further comprise a step of removing phosphate (PO₄) ions by adding calcium oxide (CaO) or calcium hydroxide (Ca(OH)₂) to a filtrate after separating the lithium phosphate, and
a molar ratio of calcium to phosphate (Ca/PO₄) may be from 1.5 to 4.5.

In some exemplary embodiments, lithium may be further recovered through an additional precipitation reaction from a filtrate after separating the lithium carbonate or the lithium phosphate, the lithium in the filtrate may be converted into an insoluble compound, Li—Al-LDH (LiAl₂(OH)₇2H₂O), by using sodium aluminate (NaAlO₂) as an additional precipitant, and a molar ratio of aluminum to lithium (Al/Li) may be from 1.5 to 5.

In some exemplary embodiments, the insoluble compound Li—Al-LDH (LiAl₂(OH)₇2H₂O) may be further subjected to a sulfuric acid roasting reaction or a salt roasting reaction followed by a water leaching reaction to produce a lithium sulfate solution, the lithium sulfate solution may be a high-concentration lithium solution suitable for producing lithium phosphate or lithium carbonate.

In some exemplary embodiments, in the sulfuric acid roasting reaction, sulfuric acid may be added, subjected to roasting, and washed with water,
a temperature of the sulfuric acid roasting reaction may range from 250° C. to 350° C.,
a sulfuric acid solution used for the sulfuric acid roasting reaction may have a concentration ranging from 2 M to 5 M, and
a lithium-enriched solution having a lithium concentration of 3000 ppm or higher may be produced.

In some exemplary embodiments, in the salt roasting reaction, sulfate may be added and subjected to the salt roasting reaction, the sulfate used for the salt roasting reaction may comprise at least one selected from the group consisting of aluminum sulfate (Al₂(SO₄)₃), magnesium sulfate (MgSO₄), sodium sulfate (Na₂SO₄), and ammonium sulfate ((NH₄)₂SO₄), and
a temperature of the salt roasting reaction may range from 500° C. to 900° C.

In some exemplary embodiments, the water leaching reaction may be performed from 1 to 5 times.

In some exemplary embodiments, in step (3), when the insoluble lithium compound is lithium carbonate,
a leaching or slurry reaction may be performed using a chlorination reactant by a wet conversion method,
the chlorination reactant may be hydrochloric acid (HCl) or calcium chloride (CaCl₂)), and
a solid-to-liquid ratio of the lithium carbonate to water may range from 100 to 300.

In some exemplary embodiments, in step (3), when the insoluble lithium compound is lithium phosphate,
a substitution reaction of a metal chloride may be performed by a wet conversion method,
the metal chloride may comprise at least one selected from the group consisting of magnesium chloride (MgCl₂), aluminum chloride (AlCl₃), and calcium chloride (CaCl₂)), a solid-to-liquid ratio of the lithium phosphate to water may range from 100 to 400, and
a molar ratio of chlorine to lithium (Cl/Li) may range from 0.5 to 1.5.

In some exemplary embodiments, a lithium chloride solution may be formed by removing metal through an additional precipitation method from a filtrate after separating a precipitate generated by the substitution reaction, and
oxalic acid may be used in the additional precipitation method.

In some exemplary embodiments, a water leaching reaction may be further performed to separate lithium components contained in a precipitate generated by the substitution reaction,
a temperature of the water leaching reaction may range from 20° C. to 80° C., and
a solid-to-liquid ratio of the precipitate to water may range from 100 to 400.

In some exemplary embodiments, in step (4), the lithium chloride powder may be produced by a crystallization method of the lithium chloride solution, and
the crystallization method may comprise at least one selected from the group consisting of vacuum drying and high-temperature drying under an inert atmosphere.

### Advantageous Effects

According to the present disclosure, a method for recovering lithium from a waste lithium primary battery leachate is provided, thereby enabling efficient separation of lithium contained in the leachate at a concentration of 0.5% to 1%, while presenting optimized conditions that suppress the incorporation of impurities. As a result, the separated lithium can be recycled as a high-purity resource, offering economic advantages.

In addition, the present disclosure provides a method for producing lithium chloride from a waste lithium primary battery leachate, enabling the production of lithium chloride with a purity of 95% or higher. By employing a relatively low-cost wet conversion method, the overall process cost can be reduced.

Furthermore, in the process of separating and converting lithium components into insoluble lithium compounds from the leachate, the present disclosure achieves a high lithium recovery rate. Compared to conventional high-temperature chlorination processes that use chlorine gas (Cl₂) for converting insoluble lithium compounds into lithium chloride, the method of the present disclosure exhibits advantages in terms of reduced process costs and improved operational safety.

### DESCRIPTION OF DRAWINGS

FIG. 1 is a schematic diagram illustrating a process for recovering lithium and producing lithium chloride from a waste lithium primary battery leachate according to an exemplary embodiment of the present disclosure.

FIG. 2 is a detailed process diagram illustrating lithium recovery and lithium chloride production from a waste lithium primary battery leachate according to an exemplary embodiment of the present disclosure.

FIG. 3 is a graph showing the concentration distribution of metal components depending on the pH of the solution when sodium hydroxide (NaOH) is added according to an exemplary embodiment of the present disclosure.

FIG. 4 is a graph showing lithium loss rate and volume ratio of 25% sodium hydroxide (NaOH) (mL) to leachate (mL) depending on the pH of the solution upon NaOH addition according to an exemplary embodiment of the present disclosure.

FIG. 5 is a graph showing the change in component concentrations before and after the addition of calcium hydroxide (Ca(OH)₂) according to an exemplary embodiment of the present disclosure.

FIG. 6 is a graph showing the concentration distribution of metal components depending on the pH of the solution upon NaOH addition according to an exemplary embodiment of the present disclosure.

FIG. 7 is a graph showing lithium loss rate and volume ratio of 25% NaOH (mL)/leachate (mL) depending on solution pH upon NaOH addition according to an exemplary embodiment of the present disclosure.

FIG. 8 is a graph showing the concentration distribution of components depending on the ratio of calcium hydroxide (Ca(OH)₂) (g)/leachate (mL) when calcium hydroxide (Ca(OH)₂) is added according to an exemplary embodiment of the present disclosure.

FIG. 9 is a graph showing lithium loss rate and solution pH change depending on the ratio of calcium hydroxide (Ca(OH)₂) (g)/leachate (mL) when calcium hydroxide (Ca(OH)₂) is added according to an exemplary embodiment of the present disclosure.

FIG. 10 is a graph showing lithium concentration and pH change in the filtrate depending on the amount of 50% sodium hydroxide (NaOH) added, after a carbonation reaction performed by adding sodium carbonate (Na₂CO₃) to the lithium purification solution such that a Li/CO₃ molar ratio becomes 2, according to an exemplary embodiment of the present disclosure.

FIG. 11 is a graph illustrating the lithium concentration in the filtrate and the carbonation conversion rate according to the reaction temperature, according to an exemplary embodiment of the present disclosure.

FIG. 12 is a graph illustrating the lithium concentration in the filtrate and the carbonation conversion rate according to the Li/CO₃ molar ratio, according to an exemplary embodiment of the present disclosure.

FIG. 13 is a graph illustrating the separation efficiency of lithium phosphate after the reaction between the lithium solution and the phosphate compound, according to an exemplary embodiment of the present disclosure.

FIG. 14 is a graph illustrating the separation efficiency of lithium phosphate according to the pH of the solution, by adding a sodium hydroxide (NaOH) solution in different Na/PO₄ ratios during the conversion of lithium in the lithium purification solution to lithium phosphate using phosphoric acid (H₃PO₄), according to an exemplary embodiment of the present disclosure.

FIG. 15 is a graph illustrating the conversion rate of lithium phosphate and the distribution of ions in the filtrate according to the Li/PO₄ molar ratio, according to an exemplary embodiment of the present disclosure.

FIG. 16 is a graph illustrating the residual lithium concentration and recovery rate according to the phosphate/lithium (PO₄/Li) molar ratio during the conversion of lithium (Li) in the lithium carbonate conversion filtrate to lithium phosphate (Li₃PO₄), according to an exemplary embodiment of the present disclosure.

FIG. 17 is a graph illustrating the distribution of ions contained in the lithium phosphate conversion filtrate according to the amount of calcium hydroxide (Ca(OH)₂) added, according to an exemplary embodiment of the present disclosure.

FIG. 18 is a graph illustrating the lithium ion concentration in the recovered solution after water leaching, depending on the roasting temperature of Li—Al LDH(LiAl₂(OH)₇2H₂O) and sulfur compounds, according to an exemplary embodiment of the present disclosure.

FIG. 19 is a graph illustrating the lithium ion concentration in the extracted solution per extraction cycle, obtained by mixing Li—Al LDH(LiAl₂(OH)₇2H₂O) with sulfuric acid solution, roasting the mixture at 300° C. for 1 hour, performing water leaching under a condition of a solid (product, g)/liquid (water, L) ratio of 100, and recirculating the filtered solution, according to an exemplary embodiment of the present disclosure.

FIG. 20 is a graph showing the thermodynamic analysis results of the conversion reaction from lithium carbonate to lithium chloride, according to an exemplary embodiment of the present disclosure.

FIG. 21a is an XRD pattern of a product recovered after vacuum drying a hydrochloric acid leaching solution of lithium carbonate at 80° C. for 24 hours and subsequently drying it at 200° C. for 1 hour under an inert atmosphere, according to an exemplary embodiment of the present disclosure.

FIG. 21b is an XRD pattern of a product recovered after vacuum drying a hydrochloric acid leaching solution of lithium carbonate for 8 hours, according to an exemplary embodiment of the present disclosure.

FIG. 22 is an XRD pattern of a product recovered after drying a hydrochloric acid leaching solution of lithium phosphate at 200° C. for 3 hours under an inert atmosphere, according to an exemplary embodiment of the present disclosure.

FIG. 23 is an XRD pattern of a by-product (precipitate) generated after a wet conversion reaction of lithium phosphate with a calcium chloride (CaCl₂)) solution, according to an exemplary embodiment of the present disclosure.

FIG. 24a is a graph showing changes in calcium ion content in the filtrate and lithium loss rate depending on the amount (mL) of 10% oxalic acid (HO₂C—CO₂H) added, based on 30 mL of lithium chloride solution recovered after preparing the lithium chloride solution and separating the precipitate under conditions of a Cl/Li molar ratio of 0.95 and a solid (Li₃PO₄)/liquid (H₂O) ratio of 200, according to an exemplary embodiment of the present disclosure.

FIG. 24b is a graph showing changes in calcium ion content in the filtrate and lithium loss rate depending on the amount (mL) of 10% oxalic acid (HO₂C—CO₂H) added, based on 30 mL of lithium chloride solution recovered after preparing the lithium chloride solution and separating the precipitate under conditions of a Cl/Li molar ratio of 1 and a solid (Li₃PO₄)/liquid (H₂O) ratio of 200, according to an exemplary embodiment of the present disclosure.

FIG. 25 is an X-ray diffraction (XRD) pattern of a product recovered after treating a lithium chloride solution with oxalic acid and vacuum drying the solution at 80° C., according to an exemplary embodiment of the present disclosure.

FIG. 26a is a graph showing the ion distribution, lithium (Li) conversion rate, and solution purity in the lithium chloride solution depending on the Cl/Li molar ratio, when the solid (Li₃PO₄, g)/liquid (H₂O, L) ratio is 100, according to an exemplary embodiment of the present disclosure.

FIG. 26b is a graph showing the ion distribution, lithium (Li) conversion rate, and solution purity in the lithium chloride solution depending on the Cl/Li molar ratio, when the solid (Li₃PO₄, g)/liquid (H₂O, L) ratio is 200, according to an exemplary embodiment of the present disclosure.

FIG. 26c is a graph showing the ion distribution, lithium (Li) conversion rate, and solution purity in the lithium chloride solution depending on the Cl/Li molar ratio, when the solid (Li₃PO₄, g)/liquid (H₂O, L) ratio is 300, according to an exemplary embodiment of the present disclosure.

FIG. 26d is a graph showing the ion distribution, lithium (Li) conversion rate, and solution purity in the lithium chloride solution depending on the Cl/Li molar ratio, when the solid (Li₃PO₄, g)/liquid (H₂O, L) ratio is 400, according to an exemplary embodiment of the present disclosure.

FIG. 27a is a graph showing the concentration of anions contained in a lithium chloride solution depending on the Cl/Li molar ratio, when the solid (Li₃PO₄, g)/liquid (H₂O, L) ratio is 100, according to an exemplary embodiment of the present disclosure.

FIG. 27b is a graph showing the concentration of anions contained in a lithium chloride solution depending on the Cl/Li molar ratio, when the solid (Li₃PO₄, g)/liquid (H₂O, L) ratio is 200, according to an exemplary embodiment of the present disclosure.

FIG. 27c is a graph showing the concentration of anions contained in a lithium chloride solution depending on the Cl/Li molar ratio, when the solid (Li₃PO₄, g)/liquid (H₂O, L) ratio is 300, according to an exemplary embodiment of the present disclosure.

FIG. 27d is a graph showing the concentration of anions contained in a lithium chloride solution depending on the Cl/Li molar ratio, when the solid (Li₃PO₄, g)/liquid (H₂O, L) ratio is 400, according to an exemplary embodiment of the present disclosure.

FIG. 28 is an X-ray diffraction (XRD) pattern of a powder recovered after vacuum drying a lithium chloride solution at 80° C. for 24 hours, according to an exemplary embodiment of the present disclosure.

### BEST MODE

Therefore, a purpose of the present disclosure is to provide a method for recovering lithium in a concentration of 0.5% to 1% contained in a waste lithium primary battery leachate. The lithium can be recovered from the waste lithium primary battery leachate by purifying impurities from the waste lithium primary battery leachate to form a lithium-purified solution and recovering lithium components from the lithium-purified solution as an insoluble lithium compound.

In addition, another purpose of the present disclosure is to provide a method for producing lithium chloride from a waste lithium primary battery leachate, wherein the insoluble lithium compound is converted into a lithium chloride solution through a wet conversion reaction, and the lithium chloride solution is crystallized to produce lithium chloride having a purity of 95% or higher.

### MODE FOR INVENTION

Hereinafter, exemplary embodiments of the present disclosure will be described in detail with reference to related drawings.

Advantages and features of the present disclosure and methods to implement them will now be described more fully hereinafter with reference to exemplary embodiments accompanied by drawings.

The present disclosure may, however, be embodied in different forms and should not be construed as limited to the exemplary embodiments set forth herein. Rather, these exemplary embodiments are provided so that this disclosure will be thorough and complete, and will fully convey the scope of the present disclosure to those skilled in the art. The scope of the present disclosure shall be defined only by the scope of claims.

When it is determined that a detailed description about known function or structure relating to the present disclosure may evade the main point of the present disclosure, the detailed description may be omitted.

Hereinafter, a detailed description of the present disclosure is provided.

Method for Recovering Lithium from Waste Lithium Primary Battery Leachate and Producing Lithium Chloride Therefrom

The present disclosure provides a method for recovering lithium from waste lithium primary battery leachate and producing lithium chloride therefrom.

According to the present disclosure, the method for recovering lithium from waste primary lithium battery leachate and producing lithium chloride therefrom may comprise the steps of:
(1) preparing a lithium purification solution by separating impurities from a leachate of a waste primary lithium battery;
(2) separating an insoluble lithium compound, which is lithium phosphate (Li₃PO₄) or lithium carbonate (Li₂CO₃), from the lithium purification solution;
(3) converting the insoluble lithium compound into a lithium chloride solution; and
(4) producing lithium chloride powder from the lithium chloride solution.

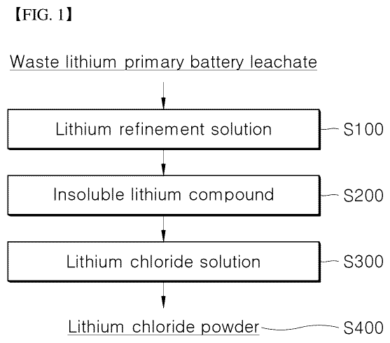

FIG. 1 is a schematic diagram illustrating a process for recovering lithium and producing lithium chloride from a waste lithium primary battery leachate according to an exemplary embodiment of the present disclosure.

Referring to FIG. 1, at first, impurities are removed from the waste lithium primary battery leachate to prepare a lithium refinement solution (S100).

Next, an insoluble lithium compound is formed and separated from the lithium refinement solution (S200).

Then, a lithium chloride solution is formed from the insoluble lithium compound (S300).

Thereafter, lithium chloride powder is produced from the lithium chloride solution (S400).

Referring to FIG. 1 for more details,

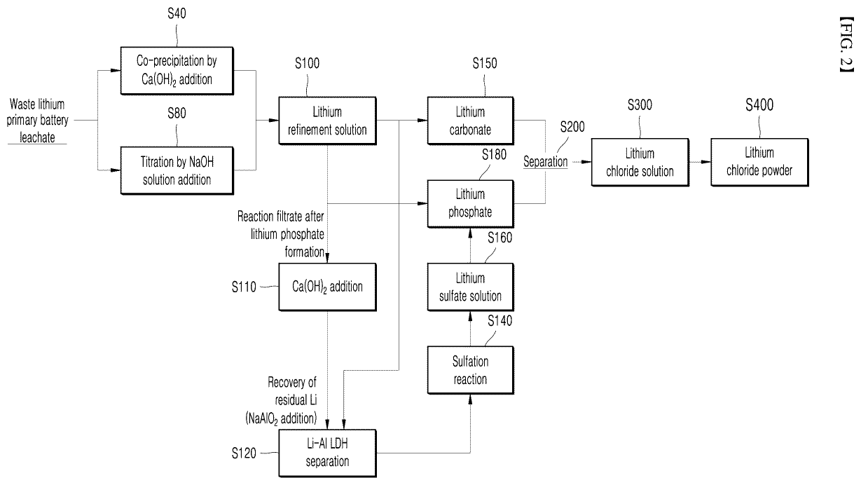

FIG. 2 is a detailed process diagram illustrating lithium recovery and lithium chloride production from a waste lithium primary battery leachate according to an exemplary embodiment of the present disclosure.

Referring to FIG. 2, from the waste lithium primary battery leachate, impurities are removed by a co-precipitation method using calcium hydroxide (Ca(OH)₂) (S40) or by titration with a sodium hydroxide (NaOH) solution (S80), thereby producing a lithium refinement solution (S100).

Next, from the lithium refinement solution, insoluble lithium compounds such as lithium carbonate (S150) or lithium phosphate (S180) are formed and separated (S200).

At this point, after the separation of lithium phosphate, calcium hydroxide (Ca(OH)₂) is added as a precipitant (S110) to remove impurities, and sodium aluminate (NaAlO₂) is added (S110) to recover lithium ions remaining in the filtrate, thereby forming an insoluble lithium compound Li—Al LDH(LiAl₂(OH)₇2H₂O) is then separated (S120).

In addition, after the separation of lithium carbonate, sodium aluminate (NaAlO₂) is added (S120) to recover remaining lithium ions and separate the insoluble lithium compound that is Li—Al LDH(LiAl₂(OH)₇2H₂O).

Subsequently, the insoluble lithium compound Li—Al LDH(LiAl₂(OH)₇2H₂O) is subjected to sulfuric acid roasting and water leaching (S140) to be converted into a lithium sulfate solution (S160).

The lithium sulfate solution may be recycled as a feedstock for producing lithium phosphate (S180).

Thereafter, a lithium chloride solution is formed from the insoluble lithium compound (S300).

Subsequently, the lithium chloride powder is produced from the lithium chloride solution (S400).

According to the present disclosure, since it provides a method for recovering lithium from a waste lithium primary battery leachate, lithium contained in the leachate at a concentration of 0.5% to 1% can be efficiently separated, and optimized conditions are provided to suppress impurity contamination. The separated lithium can be recycled as a high-purity resource, offering economic advantages.

In addition, the present disclosure provides a method for producing lithium chloride from the waste lithium primary battery leachate, whereby lithium chloride with a purity of 95% or higher can be produced from the leachate. Moreover, since a relatively low-cost wet conversion method is applied, the process cost can be reduced.

Furthermore, the present disclosure enables high recovery efficiency in the process of separating and converting lithium components into insoluble lithium compounds from the waste lithium primary battery leachate. Compared to high-temperature chlorination using chlorine gas (Cl₂) for converting insoluble lithium compounds to lithium chloride, the method of the present disclosure offers advantages in terms of reduced process cost and improved operational safety.

Here, in step (1), the leachate of the waste primary lithium battery may comprise at least one selected from the group consisting of lithium (Li), nickel (Ni), aluminum (Al), magnesium (Mg), calcium (Ca), cobalt (Co), manganese (Mn), silicon (Si), copper (Cu), vanadium (V), sodium (Na), potassium (K), chromium (Cr), iron (Fe), and zinc (Zn).

In addition, in step (1), the impurities may be separated from the leachate of the waste primary lithium battery by a pH adjustment method or a co-precipitation method.

Here, the pH adjustment method may be performed using an alkaline solution, the alkaline solution comprising at least one selected from the group consisting of sodium hydroxide (NaOH), potassium hydroxide (KOH), sodium carbonate (Na₂CO₃), sodium bicarbonate (NaHCO₃), potassium carbonate (K₂CO₃), and potassium bicarbonate (KHCO₃), and a range of the pH may be from 3 to 11.

Here, when the pH range is within the specified range, most of the +2/+3 valence metal ions can be removed.

In this case, the pH range may preferably be from 5 to 10, and more preferably from 6 to 10.

In addition, at this pH range, the lithium component in the leachate may react with aluminum impurities to form an insoluble compound, Li—Al-LDH(LiAl₂(OH)₇2H₂O), requiring additional purification.

Here, the co-precipitation method may be performed using a co-precipitant, the co-precipitant may be calcium oxide (CaO) or calcium hydroxide (Ca(OH)₂).

In this context, the co-precipitation refers to a method in which various different ions are precipitated simultaneously in an aqueous or non-aqueous solution.

In addition, a molar ratio of metal ions in the co-precipitant to the impurities (Al+Cr+Fe) may be from 0.5 to 2.

Here, when the molar ratio of metal ions/impurities (Al+Cr+Fe) in the co-precipitant is within the above range, the co-precipitation efficiency can be improved to effectively remove impurities contained in the leachate.

The molar ratio of metal ions/impurities (Al+Cr+Fe) in the co-precipitant may range from 0.5 to 1.8, and preferably from 0.7 to 1.5.

In this case, when the co-precipitant is added by the co-precipitation method, there is a problem in that metal ions from the co-precipitant may be incorporated as impurities, thereby reducing the recovery rate of lithium components. Therefore, removal of impurities through pH adjustment should be considered.

In addition, in step (2), the insoluble lithium compound separated from the lithium purification solution may be lithium carbonate or lithium phosphate.

Here, the lithium carbonate may be obtained by a carbonation reaction,
the carbonation reaction may further include a step of adjusting pH,
a range of the pH may be from 7 to 12,
a molar ratio of lithium to carbonate (Li/CO₃) may be from 1 to 2.5, and
a temperature of the carbonation reaction may be from 50° C. to 100° C.

Here, the carbonation reaction may use sodium carbonate (Na₂CO₃), potassium carbonate (K₂CO₃), and carbon dioxide (CO₂) as reactants.

When the pH range is within the specified limits, the efficiency of the carbonation reaction can be improved.

Accordingly, the pH range may preferably be from 8 to 11, and more preferably from 9 to 11.

In addition, when the reaction temperature is within the specified range, the lithium recovery rate from lithium carbonate may be increased, and insoluble lithium compounds can be separated by adjusting only the molar ratio of lithium to carbonate (Li/CO₃) without additional mixing of sodium hydroxide (NaOH).

Here, the reaction temperature may preferably be from 50° C. to 90° C., and more preferably from 60° C. to 80° C.

In addition, the lithium phosphate may be obtained by a precipitation method using a precipitant,
the precipitant may be at least one selected from the group consisting of phosphoric acid (H₃PO₄), sodium phosphate (Na₃PO₄), and ammonium phosphate ((NH₄)₂HPO₄),
sodium hydroxide (NaOH) may be mixed with the precipitant to adjust pH,
a range of the pH may be from 8 to 14,
a molar ratio of lithium to phosphate (Li/PO₄) may be from 2 to 6, and
a molar ratio of sodium to phosphate (Na/PO₄) may be from 2 to 5.

In this case, when trisodium phosphate (Na₃PO₄) is used as the precipitant, the separation efficiency can be similar to that obtained using a mixed solution of sodium hydroxide (NaOH) and phosphoric acid (H₃PO₄).

Here, using a mixed solution of sodium hydroxide (NaOH) and phosphoric acid (H₃PO₄) as the precipitant may be economical in terms of raw material cost.

When the pH range is within the specified limits, the recovery rate of lithium phosphate can be increased.

The pH range may preferably be from 8 to 13, and more preferably from 9 to 12.

In addition, when the molar ratio of lithium to phosphate (Li/PO₄) is within the specified range, the amount of unreacted residual ions can be suppressed, and the lithium ion recovery rate can be improved.

Here, the molar ratio of lithium to phosphate (Li/PO₄) may preferably be from 2.4 to 4.25, and more preferably from 2.73 to 3.33.

In addition, the method may further comprise a step of removing phosphate (PO₄) ions by adding calcium oxide (CaO) or calcium hydroxide (Ca(OH)₂) to a filtrate after separating the lithium phosphate, and a molar ratio of calcium to phosphate (Ca/PO₄) may be from 1.5 to 4.5.

In this case, when the molar ratio of calcium to phosphate (Ca/PO₄) is within the specified range, phosphate (PO₄) ions can be effectively removed.

Accordingly, the molar ratio of calcium to phosphate (Ca/PO₄) may preferably be from 2 to 4.5, and more preferably from 2.5 to 4.

In addition, lithium may be further recovered through an additional precipitation reaction from a filtrate after separating the lithium carbonate or the lithium phosphate,
the lithium in the filtrate may be converted into an insoluble compound, Li—Al-LDH (LiAl₂ (OH)₇2H₂O), by using sodium aluminate (NaAlO₂) as an additional precipitant, and a molar ratio of aluminum to lithium (Al/Li) may be from 1.5 to 5.

In this case, when sodium aluminate (NaAlO₂) is used as an additional precipitant, the recovery rate of residual lithium from the lithium refinement solution can be increased due to the low solubility of the resulting insoluble compound, Li—Al-LDH(LiAl₂(OH)₇2H₂O). In addition, when the aluminum-to-lithium (Al/Li) molar ratio is 3 or higher, the recovery rate of residual lithium may reach 99%.

Here, the insoluble compound Li—Al-LDH(LiAl₂(OH)₇2H₂O) may be further subjected to a sulfuric acid roasting reaction or a salt roasting reaction followed by a water leaching reaction to produce a lithium sulfate solution,
the lithium sulfate solution may be a high-concentration lithium solution suitable for producing lithium phosphate or lithium carbonate.

Here, in the sulfuric acid roasting reaction, sulfuric acid may be added, subjected to roasting, and washed with water,
a temperature of the sulfuric acid roasting reaction may range from 250° C. to 350° C.,
a sulfuric acid solution used for the sulfuric acid roasting reaction may have a concentration ranging from 2 M to 5 M, and
a lithium-enriched solution having a lithium concentration of 3000 ppm or higher may be produced.

In the sulfuric acid roasting reaction, the sulfate-to-lithium (SO₄/Li) molar ratio may range from 0.5 to 1, and the solid (Li—Al-LDH(LiAl₂(OH)₇2H₂O), g) to liquid (sulfuric acid, L) ratio may be 1000 during mixing prior to the roasting reaction.

In this case, when the concentration range of the sulfuric acid solution for the roasting reaction or the sulfate-to-lithium (SO₄/Li) molar ratio deviates from the above range, there may be a problem of increased incorporation of aluminum components along with the lithium component.

In addition, in the salt roasting reaction, sulfate may be added and subjected to the salt roasting reaction,
the sulfate used for the salt roasting reaction may comprise at least one selected from the group consisting of aluminum sulfate (Al₂(SO₄)₃), magnesium sulfate (MgSO₄), sodium sulfate (Na₂SO₄), and ammonium sulfate ((NH₄)₂SO₄), and a temperature of the salt roasting reaction may range from 500° C. to 900° C.

The lithium-to-sulfate (Li/SO₄) molar ratio may range from 0.5 to 2.5.

Here, when aluminum sulfate (Al₂(SO₄)₃), magnesium sulfate (MgSO₄), or ammonium sulfate ((NH₄)₂SO₄) is used as the sulfate for the salt-roasting reaction, and the reaction is performed at 700° C., the concentration of lithium ions in the solution obtained after the salt-roasting and subsequent water leaching exceeds 2000 ppm, which is a concentration suitable for recycling as a lithium phosphate precursor.

When the salt-roasting temperature is within this range, it may help produce a high-concentration lithium solution in the subsequent water leaching process.

Therefore, the preferred salt-roasting temperature may range from 600° C. to 900° C., and more preferably from 600° C. to 800° C.

The lithium-to-sulfate (Li/SO₄) molar ratio may be preferably from 0.7 to 2.3, and more preferably from 0.8 to 2.

In addition, after the sulfuric acid roasting or salt-roasting reaction, the roasted product may be subjected to water leaching at a solid (product, g) to liquid (water, L) ratio of 100 to separate lithium ions.

Furthermore, the water leaching reaction may be performed from 1 to 5 times.

In this case, as the number of water leaching cycles increases within the specified range, the concentration of lithium ions in the lithium solution increases, thereby enabling the production of a high-concentration lithium solution suitable for lithium carbonate production.

In addition, in step (3), when the insoluble lithium compound is lithium carbonate,
a leaching or slurry reaction may be performed using a chlorination reactant by a wet conversion method,
the chlorination reactant may be hydrochloric acid (HCl) or calcium chloride (CaCl₂)), and
a solid-to-liquid ratio of the lithium carbonate to water may range from 100 to 300.

Further, the reaction temperature may range from 20° C. to 80° C.

Conventional wet conversion methods using chlorinating agents generally involve mixing insoluble lithium compounds with hydrochloric acid (HCl), calcium chloride (CaCl₂)), or aluminum chloride (AlCl₃), followed by heat treatment to induce conversion, and subsequently performing water leaching to separate insoluble components.

However, in the case of high-temperature calcination reactions, the generated lithium chloride (LiCl) tends to vaporize due to its vapor pressure properties, resulting in loss, and the process is costly.

Therefore, the wet conversion method of the present disclosure adopts a lithium carbonate chlorination reaction, which is thermodynamically feasible and comparatively economical in terms of process cost.

In this case, when the solid-to-liquid ratio of lithium carbonate to water increases within the specified range, the concentration of lithium ions in the filtrate also may increase, thereby enhancing lithium recovery efficiency.

In some exemplary embodiments, in step (3), when the insoluble lithium compound is lithium phosphate,
a substitution reaction of a metal chloride may be performed by a wet conversion method,
the metal chloride may comprise at least one selected from the group consisting of magnesium chloride (MgCl₂), aluminum chloride (AlCl₃), and calcium chloride (CaCl₂)),
a solid-to-liquid ratio of the lithium phosphate to water may range from 100 to 400, and
a molar ratio of chlorine to lithium (Cl/Li) may range from 0.5 to 1.5.

In this case, when the metal chlorides are aluminum chloride (AlCl₃) and calcium chloride (CaCl₂)), the lithium concentration in the lithium chloride solution may be the highest.

Moreover, when the solid-to-liquid ratio of lithium phosphate to water increases within the specified range, phosphate (PO₄) present in the filtrate can be efficiently removed.

In addition, when the chlorine-to-lithium (Cl/Li) molar ratio is within the specified range, the efficiency of lithium chloride production can be improved.

Therefore, the chlorine-to-lithium (Cl/Li) molar ratio may preferably range from 0.8 to 1.3, and more preferably from 0.95 to 1.0.

In addition, a lithium chloride solution may be formed by removing metal through an additional precipitation method from a filtrate after separating a precipitate generated by the substitution reaction, and
oxalic acid may be used in the additional precipitation method.

In this case, the oxalic acid reacts with calcium (Ca) ions to form a precipitate of calcium oxalate (CaC₂O₄), and the solubility of this precipitate is as low as 0.61 mg/100 mL of H₂O, thereby allowing for efficient removal of calcium (Ca) ions.

In addition, a water leaching reaction may be further performed to separate lithium components contained in a precipitate generated by the substitution reaction,
a temperature of the water leaching reaction may range from 20° C. to 80° C., and
a solid-to-liquid ratio of the precipitate to water may range from 100 to 400.

In this case, as the solid-to-liquid (solid precipitate/water) ratio increases, it becomes easier to produce a high-concentration lithium solution. However, as the solid-to-liquid (solid precipitate/water) ratio increases, the moisture content also increases, requiring an appropriate solid-to-liquid ratio condition.

In addition, when the reaction temperature of the water leaching is within the specified range, further wet conversion reactions of the unreacted components may proceed along with the wet conversion reactions of the residual lithium components, thereby increasing the concentration of the recovered lithium components.

Therefore, the water leaching reaction temperature may preferably range from 30° C. to 80° C., and more preferably from 40° C. to 80° C.

In addition, in step (4), the lithium chloride powder may be produced by a crystallization method of the lithium chloride solution, and
the crystallization method may comprise at least one selected from the group consisting of vacuum drying and high-temperature drying under an inert atmosphere.

In this case, vacuum drying or high-temperature drying in an inert atmosphere of the lithium chloride solution can remove residual moisture from the surface.

The vacuum drying temperature may range from room temperature to 100° C., and the temperature for high-temperature drying in an inert atmosphere may be increased up to 200° C.

Hereinafter, the present disclosure will be described in greater detail by way of exemplary embodiments. It should be understood, however, that the following exemplary embodiments are provided solely for the purpose of illustrating the present disclosure in detail and are not intended to limit the scope thereof. Various modifications and alterations may be made by those skilled in the art without departing from the scope and spirit of the present disclosure.

### EXEMPLARY EMBODIMENTS

### <Exemplary Embodiment 1> Component and Content Analysis of Waste Lithium Primary Battery Leachate

### <Exemplary Embodiment 1-1> Component and Content Analysis of Waste Lithium Primary Battery Leachate Sample I

A portion of a 20 L waste lithium primary battery leachate (Sample I), provided by Company A, a waste lithium primary battery collection company, was taken and analyzed for the components and contents contained in the leachate using ICP (PerkinElmer 7300 DV). The results are shown in [Table 1].

TABLE 1

| Component | Li | Ni | Al | Mg | Ca | Cr | Co | Mn | Si | Fe | Zn | Cu | V | Na | K |
|---|---|---|---|---|---|---|---|---|---|---|---|---|---|---|---|
| Content | 12821 | 125 | 3636 | 294 | 243 | 5432 | 5 | 661 | 47 | 33037 | 5179 | 4 | 5 | 257 | 110 |
| (ppm) | | | | | | | | | | | | | | | |

Referring to [Table 1] in particular, the lithium (Li), which is the main component in Exemplary Embodiment 1, is present at approximately 12,821 ppm, while iron (Fe), chromium (Cr), and aluminum (Al) are present at concentrations of 33,037 ppm, 5,432 ppm, and 3,636 ppm, respectively. The pH of the solution was confirmed to be approximately 2.9.

### <Exemplary Embodiment 1-2> Component and Content Analysis of Waste Lithium Primary Battery Leachate Sample II

Using 20 L of waste lithium primary battery leachate (Sample II) provided by Company A, a waste lithium battery collection company, the components and contents of the leachate were analyzed using the same method as in Exemplary Embodiment 1-1. The results are shown in [Table 2].

TABLE 2

| Component | Li | Ni | Al | Mg | Ca | Cr | Co | Mn | Si | Fe | Zn | Cu | V | Na | K |
|---|---|---|---|---|---|---|---|---|---|---|---|---|---|---|---|
| Content | 9208 | 7.5 | 1904 | 16.2 | 157.3 | 585.4 | 0 | 406.1 | 6.5 | 18718 | 9.9 | 0 | 0 | 240.5 | 79.2 |
| (ppm) | | | | | | | | | | | | | | | |

Upon closer examination of [Table 2], the main component lithium (Li) in the exemplary embodiment shows a content of approximately 9,208 ppm, while iron (Fe), chromium (Cr), and aluminum (Al) show contents of 18,718 ppm, 585 ppm, and 1,904 ppm, respectively. The pH of the solution was confirmed to be approximately 2.9.

### <Exemplary Embodiment 2> Impurity Separation and Purification from Waste Lithium Primary Battery Leachate

An impurity separation and purification experiment from a waste lithium primary battery leachate was conducted using the method shown in FIG. 2.

### <Exemplary Embodiment 2-1> Impurity Separation and Purification Through pH Adjustment from Waste Lithium Primary Battery Leachate

Using Exemplary Embodiment 1-1, 25% sodium hydroxide (NaOH) was added to 50 mL of the waste lithium primary battery leachate to adjust the pH, and the mixture was stirred at 300 rpm under room temperature conditions for 12 hours.

As a result of analyzing Exemplary Embodiment 2-1, the component concentrations at different pH levels depending on the amount of added sodium hydroxide (NaOH) were analyzed using ICP (PerkinElmer 7300 DV) and are shown in [Table 3].

TABLE 3

| | NaOH | Li | Ni | Al | Mg | Ca | Cr | Co |
|---|---|---|---|---|---|---|---|---|
| | Added | conc. | conc. | conc. | conc. | conc. | conc. | conc. |
| pH | (mL) | (ppm) | (ppm) | (ppm) | (ppm) | (ppm) | (ppm) | (ppm) |
| 2.94 | initial | 12031.06 | 128.15 | 3482.28 | 23.26 | 266.92 | 5041.47 | 4.98 |
| 3.02 | 0.05 | 11932.24 | 128.32 | 3425.76 | 23.50 | 263.98 | 4990.58 | 5.12 |
| 5.03 | 2.2 | 11372.64 | 68.05 | 105.44 | 21.89 | 164.96 | 3.96 | 3.76 |
| 7.01 | 4.3 | 10717.40 | 5.21 | 2.82 | 22.63 | 138.60 | 0.00 | 0.00 |
| 9.06 | 6 | 10101.58 | 0.00 | 0.00 | 8.90 | 22.56 | 0.00 | 0.00 |

| Mn | Si | Fe | Zn | Cu | V | Na | K |
|---|---|---|---|---|---|---|---|
| conc. | conc. | conc. | conc. | conc. | conc. | conc. | conc. |
| (ppm) | (ppm) | (ppm) | (ppm) | (ppm) | (ppm) | (ppm) | (ppm) |
| 668.44 | 46.14 | 31558.31 | 5164.46 | 3.50 | 4.94 | 234.42 | 145.33 |
| 637.79 | 39.40 | 32152.41 | 25.48 | 3.52 | 0.00 | 587.72 | 146.32 |
| 618.38 | 0.00 | 23297.21 | 39.37 | 0.00 | 0.00 | 9498.83 | 150.79 |
| 457.15 | 0.00 | 8419.14 | 9.07 | 0.00 | 0.00 | 17296.91 | 161.71 |
| 0.00 | 0.00 | 0.00 | 0.00 | 0.00 | 0.00 | 23328.20 | 165.21 |

Upon closely examining [Table 3], it was confirmed that when the solution pH increased to approximately 9.06, all +2/+3 valence metal components were removed to 0 ppm, except for magnesium (Mg) at 8.9 ppm and calcium (Ca) at 22.56 ppm.

In the case of lithium, approximately 5.9% of the initial concentration was lost, which is presumed to be due to the lithium component in the leaching solution reacting with the aluminum (Al) component to form Li—Al-LDH(LiAl₂(OH)₇2H₂O).

Therefore, when using sodium hydroxide (NaOH) for impurity removal by this method, the pH of the leaching solution should be adjusted to about 9, and a volume ratio of 25% sodium hydroxide (NaOH) to leaching solution should be applied to about 0.12.

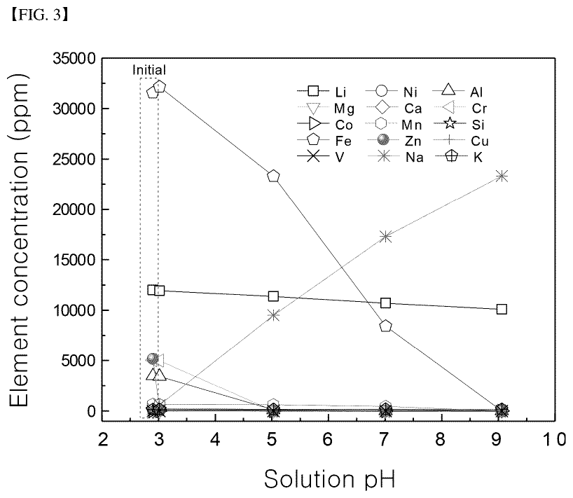

FIG. 3 is a graph showing the concentration distribution of metal components depending on the pH of the solution when sodium hydroxide (NaOH) is added according to the exemplary embodiment 2-1.

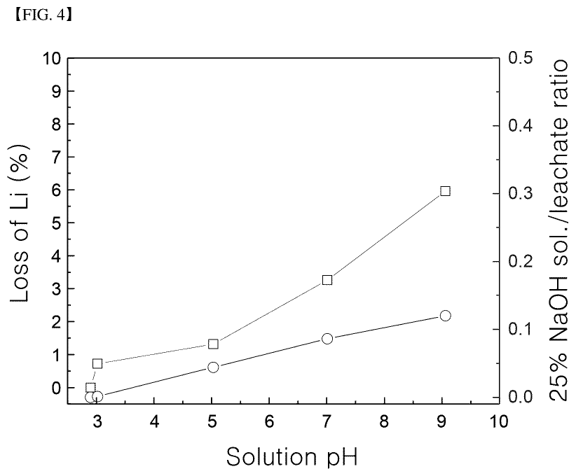

FIG. 4 is a graph showing lithium loss rate and volume ratio of 25% sodium hydroxide (NaOH) (mL) to leachate (mL) depending on the pH of the solution upon NaOH addition according to the exemplary embodiment 2-1.

Referring to FIGS. 3 and 4, as the amount of sodium hydroxide (NaOH) added increased, the pH of the solution also increased.

In addition, with the increase in solution pH, the concentrations of the other 2+/3+ valence metal components decreased except for magnesium (Mg) and calcium (Ca), but the loss of lithium also increased.

### <Exemplary Embodiment 2-2> Impurity Separation and Purification from Waste Lithium Primary Battery Leachate via Co-precipitation Method

Using the waste lithium primary battery leachate of Exemplary Embodiment 1-1, 50 mL of the leachate was treated with calcium hydroxide (Ca(OH)₂) as a co-precipitant. Based on the aluminum (Al) and iron (Fe) content in the leachate, the molar ratio of calcium (Ca) to aluminum and iron (Al, Fe) was adjusted to 1. The solution was stirred at 300 rpm at room temperature for 12 hours.

As a result of analyzing Exemplary Embodiment 2-2, the pH and component concentrations of the solution according to the amount of calcium hydroxide (Ca(OH)₂) added were measured using ICP (PerkinElmer 7300 DV) and are shown in [Table 4].

TABLE 4

| Leachate | | | | | | | | | |
|---|---|---|---|---|---|---|---|---|---|
| Volume | | | Ca(OH)₂ | Li | Ni | Al | Mg | Ca | Cr |
| Used | | | Added | conc. | conc. | conc. | conc. | conc. | conc. |
| (mL) | Condition | pH | (g) | (ppm) | (ppm) | (ppm) | (ppm) | (ppm) | (ppm) |
| Initial | | 2.94 | 0 | 12821.02 | 125.27 | 3636.34 | 294.73 | 243.35 | 5432.95 |
| 50 | Based on Al + Fe | 4.87 | 10.275 | 12439.16 | 0.00 | 0.00 | 0.00 | 23021.17 | 0.00 |
| | molar equivalent | | | | | | | | |
| | ratio (re-analysis | | | | | | | | |
| | basis) | | | | | | | | |

| Co | Mn | Si | Fe | Zn | Cu | V | Na | K |
|---|---|---|---|---|---|---|---|---|
| conc. | conc. | conc. | conc. | conc. | conc. | conc. | conc. | conc. |
| (ppm) | (ppm) | (ppm) | (ppm) | (ppm) | (ppm) | (ppm) | (ppm) | (ppm) |
| 5.24 | 661.82 | 47.56 | 33037.12 | 5179.49 | 3.94 | 4.77 | 257.75 | 110.14 |
| 0.00 | 0.00 | 0.00 | 0.00 | 12.87 | 0.00 | 0.00 | 308.33 | 129.30 |

As shown in [Table 4], all +2/+3 valent metal components were removed except for zinc (Zn), which remained at 12.8 ppm.

Furthermore, after the addition of calcium hydroxide (Ca(OH)₂), the solution pH increased from 2.9 to 4.9.

The lithium loss after impurity removal was approximately 3%, which is lower than that observed in Exemplary Embodiment 2-1 using sodium hydroxide (NaOH). However, the calcium (Ca) ion concentration in the remaining solution was measured to be 23,021 ppm. This high concentration may lead to incorporation as an impurity during the conversion to an insoluble lithium compound, potentially decreasing the lithium recovery rate.

To address this issue, it is necessary to adjust the pH to 9 prior to the conversion to an insoluble lithium compound in order to remove calcium (Ca) ions.

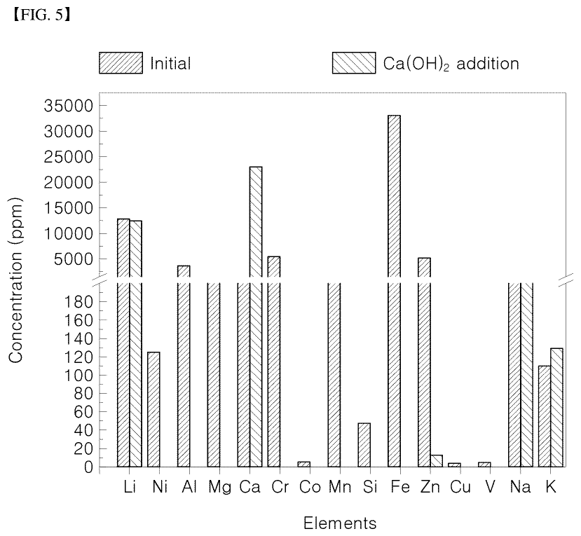

FIG. 5 is a graph showing the change in component concentrations before and after the addition of calcium hydroxide (Ca(OH)₂) according to the exemplary embodiment 2-2.

Referring to FIG. 5, it was confirmed that upon the addition of calcium hydroxide (Ca(OH)₂) according to Exemplary Embodiment 2-2, all components were removed except for lithium (Li), calcium (Ca), zinc (Zn), sodium (Na), and potassium (K).

### Exemplary Embodiment 2-3

To evaluate the reproducibility of Exemplary Embodiments 2-1 to 2-2, the procedure was performed in the same manner as in Exemplary Embodiment 2-1, except that the leachate from waste primary lithium batteries used was that of Exemplary Embodiment 1-2.

The analysis of Exemplary Embodiment 2-3 was conducted using ICP (PerkinElmer 7300 DV) to determine the pH and component concentrations of the solution depending on the amount of calcium hydroxide (Ca(OH)₂) added. The results are shown in [Table 5].

TABLE 5

| | | NaOH | Li | Ni | Al | Mg | Ca | Cr | Co |
|---|---|---|---|---|---|---|---|---|---|
| | | Added | conc. | conc. | conc. | conc. | conc. | conc. | conc. |
| Condition | pH | (mL) | (ppm) | (ppm) | (ppm) | (ppm) | (ppm) | (ppm) | (ppm) |
| Leachate + | Initial | | 9208.20 | 7.58 | 1904.59 | 16.26 | 157.37 | 585.41 | 0.00 |
| NaOH (25 %) | 4.14 | 0.11 | 9252.44 | 7.66 | 1803.02 | 16.35 | 151.90 | 327.85 | 0.00 |
| | 5.05 | 1.20 | 8911.80 | 7.14 | 180.44 | 16.10 | 131.24 | 10.87 | 0.00 |
| | 6.07 | 2.00 | 8786.87 | 2.64 | 8.23 | 15.16 | 112.56 | 0.00 | 0.00 |
| | 6.98 | 4.00 | 8515.99 | 0.00 | 0.00 | 15.43 | 97.93 | 0.00 | 0.00 |
| | 8.06 | 5.10 | 8623.22 | 0.00 | 0.00 | 12.28 | 10.38 | 0.00 | 0.00 |
| | 9.08 | 5.55 | 8267.40 | 0.00 | 0.00 | 0.00 | 0.00 | 0.00 | 0.00 |
| | 11.09 | 6.00 | 7921.87 | 0.00 | 0.00 | 0.00 | 0.00 | 0.00 | 0.00 |

| | Mn | Si | Fe | Zn | Cu | V | Na | K |
|---|---|---|---|---|---|---|---|---|
| | conc. | conc. | conc. | conc. | conc. | conc. | conc. | conc. |
| Condition | (ppm) | (ppm) | (ppm) | (ppm) | (ppm) | (ppm) | (ppm) | (ppm) |
| Leachate + | 406.17 | 6.50 | 18718.97 | 9.95 | 0.00 | 0.00 | 240.57 | 79.26 |
| NaOH (25 %) | 402.11 | 5.24 | 18006.44 | 9.78 | 0.00 | 0.00 | 640.62 | 79.62 |
| | 407.50 | 0.00 | 17446.61 | 8.84 | 0.00 | 0.00 | 4214.81 | 81.15 |
| | 379.33 | 0.00 | 13629.30 | 3.62 | 0.00 | 0.00 | 6315.33 | 83.27 |
| | 304.90 | 0.00 | 4067.69 | 0.00 | 0.00 | 0.00 | 10835.99 | 83.74 |
| | 125.77 | 0.00 | 139.83 | 0.00 | 0.00 | 0.00 | 14028.35 | 89.10 |
| | 0.00 | 0.00 | 0.00 | 0.00 | 0.00 | 0.00 | 15232.35 | 89.95 |
| | 0.00 | 0.00 | 0.00 | 0.00 | 0.00 | 0.00 | 16480.33 | 92.12 |

When examining [Table 5] in detail, it was confirmed that when the pH increased to approximately 9.08, the +2/+3 valent metal ions were removed. The lithium (Li) content showed an approximate 10.2% loss compared to the initial concentration.

Although the aluminum-to-lithium (Al/Li) weight ratio in Exemplary Embodiment 1-2 was somewhat lower at 20.6% compared to 28.3% in Exemplary Embodiment 1-1, a higher lithium loss was observed in Exemplary Embodiment 1-2.

This is considered to be due to the relatively low content of +2/+3 valent ions, which have high co-precipitation reactivity with aluminum (Al), leading to increased lithium loss despite pH adjustment.

Therefore, when sodium hydroxide (NaOH) is used for impurity removal by this method, the leachate pH should be adjusted to about 9.08, and a 25% NaOH/leachate volume ratio of about 0.11 should be applied.

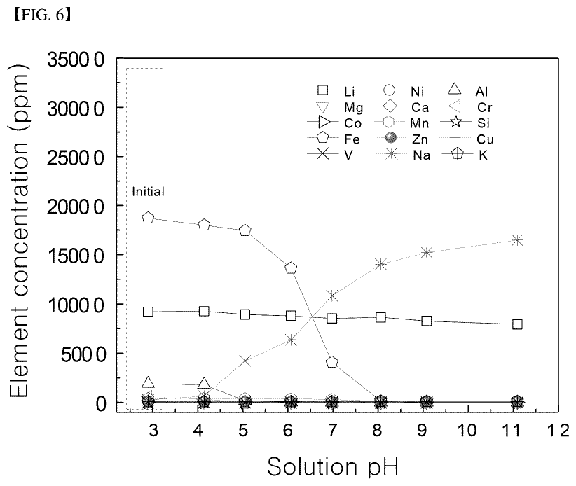

FIG. 6 is a graph showing the concentration distribution of metal components depending on the pH of the solution upon NaOH addition according to the exemplary embodiment 2-3.

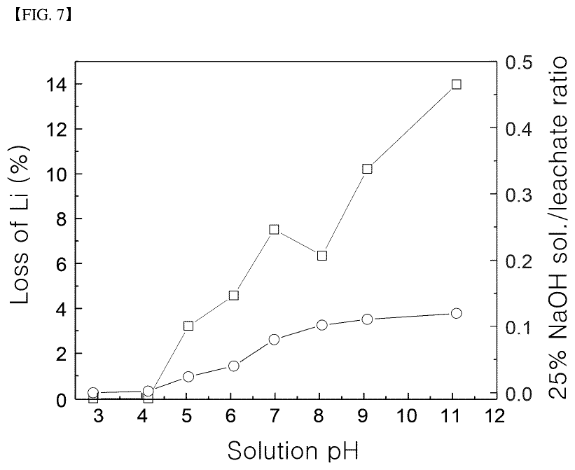

FIG. 7 is a graph showing lithium loss rate and volume ratio of 25% NaOH (mL)/leachate (mL) depending on solution pH upon NaOH addition according to the exemplary embodiment 2-3.

Referring to FIGS. 6 and 7, it was confirmed that as the amount of sodium hydroxide (NaOH) added increased, the pH also increased, and with the increase in pH, the content of +2/+3 valent metal ions decreased, but the lithium loss was relatively high.

### Exemplary Embodiment 2-4

This experiment was conducted in the same manner as in Exemplary Embodiment 2-2, except that the leaching solution of waste primary lithium batteries from Exemplary Embodiment 1-2 was used, and the molar ratio of calcium (Ca) to aluminum and iron (Al, Fe) was adjusted.

The analysis results of Exemplary Embodiment 2-4 were obtained by measuring the pH and the composition and content of the solution depending on the amount of calcium hydroxide (Ca(OH)₂) added using ICP (PerkinElmer 7300 DV), and are shown in [Table 6].

TABLE 6

| | Ca/Al + | | | | | | | |
|---|---|---|---|---|---|---|---|---|
| | Cr + Fe | Ca(OH)₂ | Li | Ni | Al | Mg | Ca | Cr |
| | molar | Added | conc. | conc. | conc. | conc. | conc. | conc. |
| pH | ratio | (g) | (ppm) | (ppm) | (ppm) | (ppm) | (ppm) | (ppm) |
| Initial | | | 9208.20 | 7.58 | 1904.59 | 16.26 | 157.37 | 585.41 |
| 5.90 | 0.7 | 1.157 | 10067.77 | 0.00 | 3.38 | 15.46 | 7803.88 | 0.00 |
| 6.07 | 0.8 | 1.323 | 9904.43 | 0.00 | 2.89 | 15.06 | 9176.50 | 0.00 |
| 6.34 | 0.9 | 1.488 | 9792.50 | 0.00 | 0.00 | 14.88 | 10173.45 | 0.00 |
| 6.81 | 1.0 | 1.654 | 9853.33 | 0.00 | 0.00 | 10.43 | 11309.30 | 0.00 |
| 7.97 | 1.1 | 1.819 | 9805.90 | 0.00 | 0.00 | 5.75 | 11836.47 | 0.00 |
| 9.68 | 1.2 | 1.984 | 9739.72 | 0.00 | 0.00 | 0.00 | 12114.07 | 0.00 |
| 10.14 | 1.3 | 2.150 | 9933.18 | 0.00 | 0.00 | 0.00 | 12418.09 | 0.00 |
| 10.65 | 1.4 | 2.315 | 9728.90 | 0.00 | 0.00 | 0.00 | 12504.64 | 0.00 |
| 11.16 | 1.5 | 2.481 | 9708.27 | 0.00 | 0.00 | 0.00 | 12613.27 | 0.00 |

| Co | Mn | Si | Fe | Zn | Cu | V | Na | K |
|---|---|---|---|---|---|---|---|---|
| conc. | conc. | conc. | conc. | conc. | conc. | conc. | conc. | conc. |
| (ppm) | (ppm) | (ppm) | (ppm) | (ppm) | (ppm) | (ppm) | (ppm) | (ppm) |
| 0.00 | 406.17 | 6.50 | 18718.97 | 9.95 | 0.00 | 0.00 | 240.57 | 79.26 |
| 0.00 | 411.32 | 0.00 | 8016.20 | 0.00 | 0.00 | 0.00 | 171.08 | 83.00 |
| 0.00 | 387.94 | 0.00 | 5275.18 | 0.00 | 0.00 | 0.00 | 171.32 | 83.98 |
| 0.00 | 361.02 | 0.00 | 2985.72 | 0.00 | 0.00 | 0.00 | 172.73 | 83.96 |
| 0.00 | 304.36 | 0.00 | 1026.10 | 0.00 | 0.00 | 0.00 | 171.35 | 84.53 |
| 0.00 | 17.13 | 0.00 | 9.06 | 0.00 | 0.00 | 0.00 | 173.65 | 83.96 |
| 0.00 | 0.00 | 0.00 | 0.00 | 0.00 | 0.00 | 0.00 | 177.51 | 84.23 |
| 0.00 | 0.00 | 0.00 | 0.00 | 0.00 | 0.00 | 0.00 | 180.33 | 84.66 |
| 0.00 | 0.00 | 0.00 | 0.00 | 0.00 | 0.00 | 0.00 | 183.30 | 85.87 |
| 0.00 | 0.00 | 0.00 | 0.00 | 0.00 | 0.00 | 0.00 | 181.96 | 86.48 |

Upon detailed examination of [Table 6], it was confirmed that when the calcium to aluminum+chromium+iron (Ca/Al+Cr+Fe) molar ratio was 1.2, most of the divalent and trivalent (+2/+3) components were effectively removed. Additionally, after the addition of calcium hydroxide (Ca(OH)₂), the residual calcium (Ca) content in the solution was observed to be approximately 12,114 ppm.

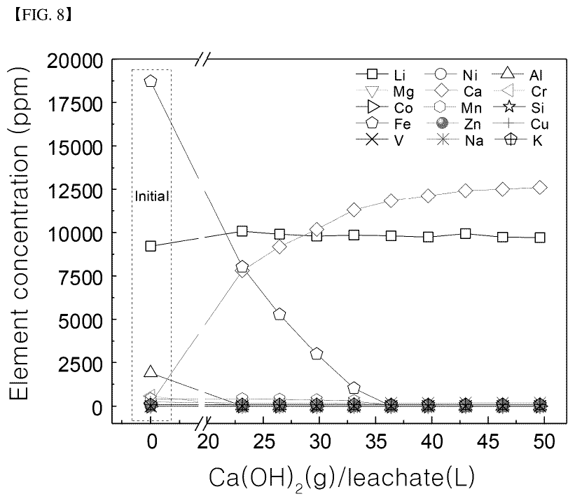

FIG. 8 is a graph showing the concentration distribution of components depending on the ratio of calcium hydroxide (Ca(OH)₂) (g)/leachate (mL) when calcium hydroxide (Ca(OH)₂) is added according to the exemplary embodiment 2-4.

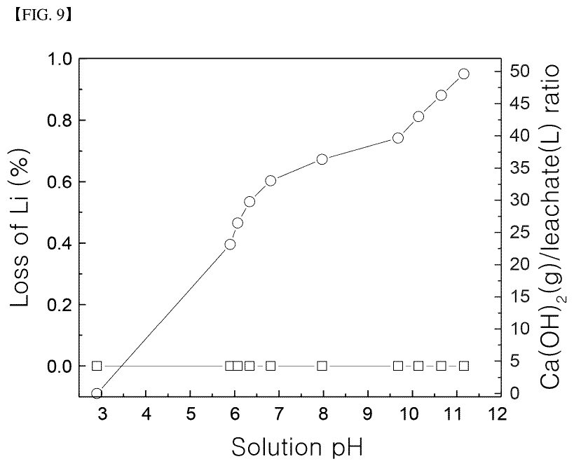

FIG. 9 is a graph showing lithium loss rate and solution pH change depending on the ratio of calcium hydroxide (Ca(OH)₂) (g)/leachate (mL) when calcium hydroxide (Ca(OH)₂) is added according to the exemplary embodiment 2-4.

Referring to FIGS. 8 and 9, it was confirmed that increasing the ratio of calcium hydroxide (Ca(OH)₂) (g) to leaching solution (mL) led to the removal of most divalent and trivalent (+2/+3) metal ions, excluding calcium (Ca), while minimizing the loss of lithium (Li).

A detailed review of Exemplary Embodiments 2-1 through 2-4 shows that, when precipitation and separation were performed using a sodium hydroxide (NaOH) solution as in Exemplary Embodiment 2-3, lithium loss during the purification process was observed to be approximately 5˜9%.

In contrast, when calcium hydroxide (Ca(OH)₂) was used for precipitation and separation, as in Exemplary Embodiment 2-4, lithium loss did not occur. However, a residual calcium (Ca) concentration of approximately 12,000 ppm remained, creating a limitation in that additional removal of calcium using sodium hydroxide (NaOH) is required in subsequent processes.

Therefore, when using a sodium hydroxide (NaOH) solution, a solution pH in the range of 8.5 to 9.5 is considered appropriate. When using calcium hydroxide (Ca(OH)₂), a calcium to aluminum+chromium+iron (Ca/Al+Cr+Fe) molar ratio in the range of 1.1 to 1.5 may be deemed suitable.

Accordingly, considering the subsequent conversion process into an insoluble lithium compound, a purified lithium solution was prepared by adjusting the pH of the leaching solution to approximately 9 using a sodium hydroxide (NaOH) solution, which provides lower lithium loss and eliminates the need for additional calcium (Ca) purification, thereby enabling precipitation, separation, and filtration of impurity components.

### <Exemplary Embodiment 3> Separation of Insoluble Lithium Compounds from the Purified Lithium Solution for Lithium Recovery

Insoluble lithium compounds were separated from the purified lithium solution using the same method as illustrated in FIG. 2.

### <Exemplary Embodiment 3-1> Separation of Insoluble Lithium Compound, Lithium Carbonate, from the Purified Lithium Solution for Lithium Recovery

After performing Exemplary Embodiment 2-3, 3.507 g of sodium carbonate (Na₂CO₃) powder was added to 50 mL of purified lithium solution containing approximately 1% lithium ion such that the molar ratio of lithium to carbonate (Li/CO₃) was 2. Then, 50% sodium hydroxide (NaOH) solution was added to adjust the pH of the solution. The carbonation reaction was carried out at room temperature with a stirring speed of 300 rpm for 12 hours to separate lithium carbonate.

As a result of analyzing Exemplary Embodiment 3-1, the lithium concentration in the filtrate was measured according to the sodium-to-lithium (Na/Li) molar ratio after the carbonation reaction was performed using sodium carbonate (Na₂CO₃) and the findings are shown in [Table 7].

TABLE 7

| | Leachate | | | Reaction | | | | | |
|---|---|---|---|---|---|---|---|---|---|
| | Volume | Li/CO₃ | Na/Li | Temperature | Stirring | Na₂CO₃ | NaOH | | Li |
| | Used | Molar | Molar | Time | Speed | Added | Added | | conc. |
| Condition | (mL) | Ratio | Ratio | (° C-h) | (RPM) | (g) | (mL) | pH | (ppm) |
| Leachate + | Initial | | | | | | | 9.44 | 9157.837 |
| 50% NaOH | 50 | 2 | 0 | Room temp.-12 | 300 | 3.507 | 0 | 11.03 | 2938.182 |
| | 50 | 2 | 0.25 | Room temp.-12 | 300 | 3.507 | 1.025 | 12.82 | 3109.465 |
| | 50 | 2 | 0.5 | Room temp.-12 | 300 | 3.507 | 2.050 | 12.91 | 3226.647 |
| | 50 | 2 | 0.75 | Room temp.-12 | 300 | 3.507 | 3.075 | 12.97 | 3412.894 |
| | 50 | 2 | 1 | Room temp.-12 | 300 | 3.507 | 4.099 | 12.99 | 3508.558 |
| | 50 | 2 | 1.5 | Room temp.-12 | 300 | 3.507 | 6.147 | 12.8 | 3765.197 |

Upon closer examination of [Table 7], when sodium carbonate (Na₂CO₃) was added to the purified lithium solution to achieve a lithium-to-carbonate (Li/CO₃) molar ratio of 2, the pH increased from 9.4 to approximately 11.03.

Subsequently, to analyze lithium recovery according to the alkalinity of the solution, 50% sodium hydroxide (NaOH) was added to further increase the pH to 12.9.

Based on the experimental results, it was confirmed that when the pH of the solution exceeded 11, the concentration of residual lithium ions in the solution increased, and the lithium recovery rate decreased.

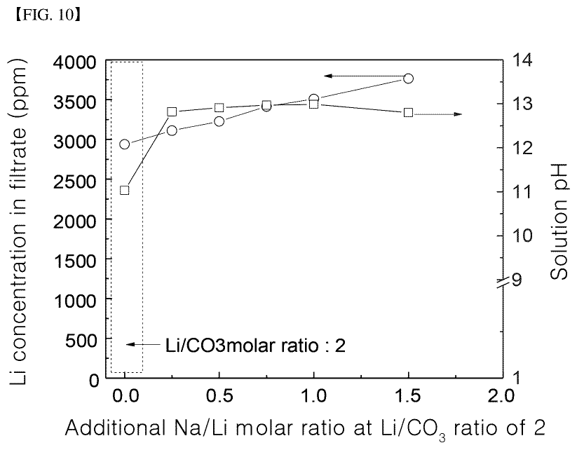

FIG. 10 is a graph showing lithium concentration and pH change in the filtrate depending on the amount of 50% sodium hydroxide (NaOH) added, after a carbonation reaction performed by adding sodium carbonate (Na₂CO₃) to the lithium purification solution such that a Li/CO₃ molar ratio becomes 2, according to the exemplary embodiment 3-1.

Referring to FIG. 10, it was confirmed that under the above conditions, as the amount of 50% sodium hydroxide (NaOH) added increased, the pH also increased and the concentration of lithium in the filtrate increased accordingly.

### <Exemplary Embodiment 3-2> Separation of Insoluble Lithium Compound, Lithium Carbonate, from the Lithium Purification Solution for Lithium Recovery

After performing Exemplary Embodiment 2-3, a carbonation reaction according to the lithium/carbonate (Li/CO₃) molar ratio was conducted to separate lithium carbonate from 100 mL of a lithium purification solution with a lithium ion concentration of 10,328.29 ppm, without adding 50% sodium hydroxide (NaOH). The reaction was carried out by adjusting the reaction temperature to 25° C. to 80° C. and stirring at 300 rpm for 8 hours.

As a result of analyzing Exemplary Embodiment 3-2, the lithium concentration contained in the filtrate was measured according to the carbonation reaction temperature and the lithium/carbonate (Li/CO₃) molar ratio, as shown in [Table 8].

TABLE 8

| | Leachate | Reaction | | | | Li |
|---|---|---|---|---|---|---|
| | Volume | Temperature/ | Stirring | LiCO₃ | Li | Conversion |
| | Used | Time | Speed | Molar | conc. | Ratio |
| Condition | (mL) | (° C-h) | (RPM) | Ratio | (ppm) | (%) |
| Li-primary | Purification_Initial | | | | 10328.29 | |
| battery | 100 | Room temp.-8 | 300 | 2.00 | 3244.21 | 68.59 |
| purified | 100 | 40-8 | 300 | 2.00 | 3038.19 | 70.58 |
| solution | 100 | 80-8 | 300 | 2.00 | 2520.51 | 75.60 |
| (NaOH) | 100 | 60-8 | 300 | 2.00 | 2625.03 | 74.58 |
| | 100 | 60-8 | 300 | 1.82 | 2396.57 | 76.80 |
| | 100 | 60-8 | 308 | 1.67 | 2053.50 | 80.12 |
| | 100 | 60-8 | 300 | 1.54 | 2045.89 | 80.19 |
| | 100 | 60-8 | 300 | 1.43 | 1934.69 | 81.27 |

As shown in Table 8, under the given reaction conditions, it was confirmed that the lithium recovery rate was higher when the reaction temperature was 60° C. or above.

Based on the stoichiometric Li/carbonate (Li/CO₃) molar ratio of 2, it was observed that increasing the amount of sodium carbonate (Na₂CO₃) led to a slight increase in recovery rate. However, when an excessive amount of precipitating agent was used, a significant amount of unreacted components remained in the filtrate after the reaction, presenting a drawback.

Therefore, when separating the insoluble compound lithium carbonate from the purified solution of the leachate of waste lithium primary batteries, the optimal condition is to carry out the separation at a reaction temperature of 60° C. to 80° C. without adding extra sodium hydroxide (NaOH), using a Li/carbonate (Li/CO₃) molar ratio of 2.

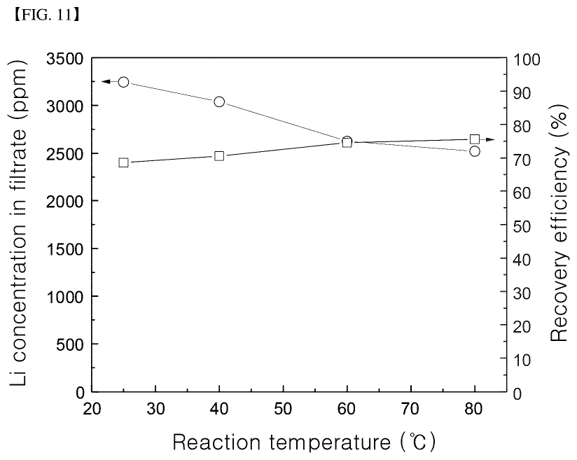

FIG. 11 is a graph illustrating the lithium concentration in the filtrate and the carbonation conversion rate according to the reaction temperature, according to the exemplary embodiment 3-2.

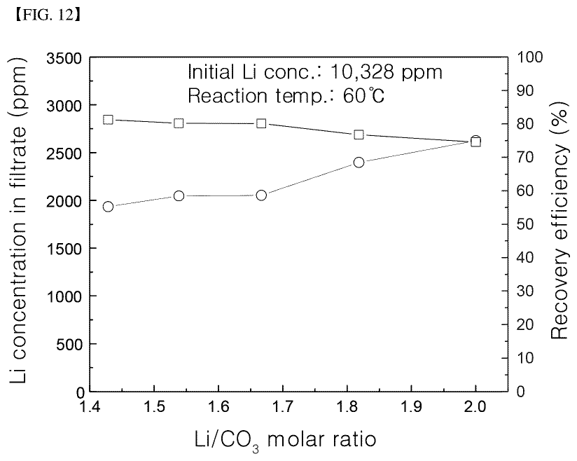

FIG. 12 is a graph illustrating the lithium concentration in the filtrate and the carbonation conversion rate according to the Li/CO₃ molar ratio, according to the exemplary embodiment 3-2.

Referring to FIGS. 11 and 12, it was confirmed that the lithium recovery rate increases at reaction temperatures of 60° C. or higher. When the reaction temperature is 60° C., the lithium concentration in the filtrate slightly increases as the Li/carbonate (Li/CO₃) molar ratio increases. However, the difference in lithium conversion rate is not significant.

Therefore, although increasing the amount of precipitant (Na₂CO₃) during the carbonation reaction may slightly improve the lithium carbonate recovery rate, the content of unreacted components (Na+, CO₃²⁻) remaining in the filtrate also increases. Hence, it is considered appropriate to recover lithium carbonate under conditions of a Li/carbonate (Li/CO₃) molar ratio of 2 and a reaction temperature of 60° C. or higher.

### <Exemplary Embodiment 3-3> Evaluation of Separation Efficiency into Insoluble Lithium Compound, Lithium Phosphate (1)

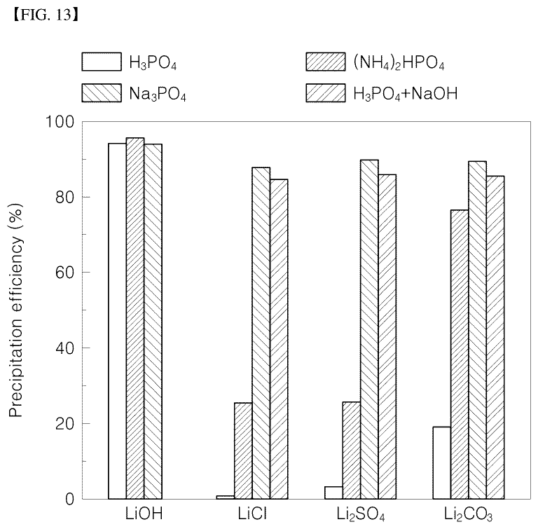

Prior to evaluating the precipitation reaction of the insoluble lithium compound from the lithium purified solution, a lithium solution with a lithium ion concentration of approximately 2,000 ppm was prepared using 200 mL of lithium hydroxide (LiOH), lithium chloride (LiCl), lithium sulfate (Li₂SO₄), and lithium carbonate (Li₂CO₃). To these solutions, phosphate-based precipitants—phosphoric acid (H₃PO₄), sodium phosphate (Na₃PO₄), ammonium phosphate ((NH₄)₂HPO₄) and a sodium hydroxide/phosphoric acid (NaOH/H₃PO₄) mixed solution—were added under the condition of a Li/phosphate (Li/PO₄) molar ratio of 3. After mixing, the solution was stirred at 300 rpm for 24 hours, and the efficiency of separation into the insoluble compound, lithium phosphate, was evaluated and shown in FIG. 13.

FIG. 13 is a graph illustrating the separation efficiency of lithium phosphate after the reaction between the lithium solution and the phosphate compound, according to the exemplary embodiment 3-3.

Referring to FIG. 13, the lithium solution using lithium hydroxide (LiOH) showed the highest lithium ion recovery rate. Among the phosphate-based precipitants used for each lithium solution, sodium phosphate (Na₃PO₄) exhibited the most effective lithium ion recovery.

In addition, compared to sodium phosphate (Na₃PO₄), the sodium hydroxide/phosphoric acid (NaOH/H₃PO₄) mixed solution (Na/PO₄ molar ratio: 3) demonstrated a somewhat similar separation efficiency.

### <Exemplary Embodiment 3-4> Evaluation of Separation Efficiency into Insoluble Lithium Compound, Lithium Phosphate (2)

After performing Exemplary Embodiment 2-3, it was confirmed that the purified lithium solution contained chloride ions (Cl) and sulfate ions (SO₄) at concentrations of approximately 43,000 ppm and over 2,800 ppm, respectively. Therefore, the conversion efficiency into lithium phosphate from lithium chloride or lithium sulfate must be considered.

Based on the results of Exemplary Embodiment 3-3, in Exemplary Embodiment 3-4, sodium hydroxide (NaOH)/phosphoric acid (H₃PO₄) was used as the precipitating agent in consideration of both the high conversion efficiency to lithium phosphate and the cost of raw materials used in the separation process. Here, the sodium hydroxide (NaOH) was used for pH adjustment.

As a result of analyzing Exemplary Embodiment 3-4, phosphoric acid (H₃PO₄) was reacted with the lithium-purified solution to convert lithium into lithium phosphate. Sodium hydroxide (NaOH) was added according to various sodium/phosphate (Na/PO₄) ratios, and the lithium phosphate separation efficiency was confirmed depending on the pH of the solution.

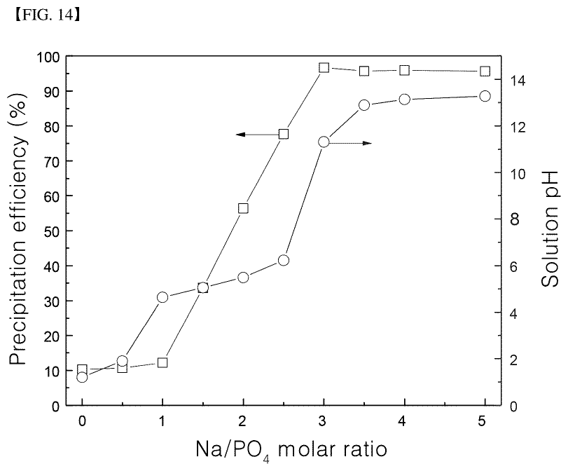

FIG. 14 is a graph illustrating the separation efficiency of lithium phosphate according to the pH of the solution, by adding a sodium hydroxide (NaOH) solution in different Na/PO₄ ratios during the conversion of lithium in the lithium purification solution to lithium phosphate using phosphoric acid (H₃PO₄), according to the exemplary embodiment 3-4.

As shown in FIG. 14, when phosphoric acid (H₃PO₄) was reacted with the lithium-purified solution and the pH was increased using sodium hydroxide (NaOH), the highest lithium phosphate recovery rate was observed under the condition where the sodium-to-phosphate (Na/PO₄) molar ratio was 3.

Therefore, based on these results, the condition with a Na/PO₄ molar ratio of 3 was applied in the following experiment.

### <Exemplary Embodiment 3-5> Separation of Insoluble Lithium Compound, Lithium Phosphate, from the Lithium-Purified Solution for Lithium Recovery

Referring to the results of Exemplary Embodiments 3-3 to 3-4, after performing Exemplary Embodiment 2-3, phosphoric acid (H₃PO₄) was added as a precipitant to 50 mL of lithium-purified solution containing approximately 10,328 ppm of lithium ions. A sodium hydroxide (NaOH) solution was then added to adjust the sodium-to-phosphate (Na/PO₄) molar ratio to 3. The mixture was stirred at room temperature at a rate of 300 rpm for 24 hours to separate lithium phosphate (Li₃PO₄), an insoluble lithium compound.

As a result of analyzing Exemplary Embodiment 3-5, under the above reaction conditions, the concentration of lithium ions remaining in the filtrate, the lithium conversion rate, and the concentrations of other ions in the filtrate were analyzed according to the lithium-to-phosphate (Li/PO₄) molar ratio and the addition of sodium hydroxide (NaOH) solution. The results are presented in [Table 9].

TABLE 9

| Leachate | Reaction | | | | | | | Li | | | | |
|---|---|---|---|---|---|---|---|---|---|---|---|---|
| Volume | Temperature/ | Stirring | Li/PO₄ | H₃PO₄ | Na/PO₄ | NaOH | Li | Conversion | Na | Cl | SO₄ | PO₄ |
| Used | Time | Speed | Molar | Added | Molar | Added | conc. | Ratio | conc. | conc. | conc. | conc. |
| (mL) | (° C-h) | (RPM) | Ratio | (mL) | Ratio | (mL) | (ppm) | (%) | (ppm) | (ppm) | (ppm) | (ppm) |
| Purification_Initial | | | | | | | 10328.29 | | | 69596.00 | 3056.20 | |
| 50 | Room temp.-24 | 300 | 6.00 | 0.89 | 3.00 | 2.05 | 4394.20 | 57.45 | 28103.46 | 69234.00 | 3026.40 | 0 |
| 50 | Room temp.-24 | 300 | 5.00 | 1.07 | 3.00 | 2.46 | 3471.39 | 66.39 | 30459.60 | 69408.00 | 2860.00 | 0 |
| 50 | Room temp.-24 | 300 | 4.29 | 1.25 | 3.00 | 2.87 | 2583.33 | 74.99 | 32075.86 | 68378.00 | 2967.66 | 0 |
| 50 | Room temp.-24 | 300 | 3.75 | 1.42 | 3.00 | 3.28 | 1759.15 | 82.97 | 34096.24 | 66796.00 | 2862.20 | 0 |
| 50 | Room temp.-24 | 300 | 3.33 | 1.60 | 3.00 | 3.69 | 862.41 | 91.65 | 36434.43 | 67308.00 | 2848.00 | 154.28 |
| 50 | Room temp.-24 | 300 | 3.00 | 1.78 | 3.00 | 4.10 | 370.81 | 96.41 | 37734.55 | 66592.00 | 2840.40 | 1202.96 |
| 50 | Room temp.-24 | 300 | 2.73 | 1.96 | 3.00 | 4.51 | 252.25 | 97.56 | 39183.83 | 65768.00 | 2939.00 | 3257.80 |
| 50 | Room temp.-24 | 300 | 2.50 | 2.14 | 3.00 | 4.92 | 240.60 | 97.67 | 41119.58 | 65562.00 | 2933.60 | 5208.60 |
| 50 | Room temp.-24 | 300 | 2.31 | 2.31 | 3.00 | 5.33 | 223.25 | 97.84 | 42323.68 | 64294.00 | 2843.60 | 8522.00 |
| 50 | Room temp.-24 | 300 | 2.14 | 2.49 | 3.00 | 5.74 | 202.63 | 98.04 | 44404.43 | 62510.00 | 2820.60 | 12259.00 |
| 50 | Room temp.-24 | 300 | 2.00 | 2.67 | 3.00 | 6.15 | 190.82 | 98.15 | 46267.63 | 61792.00 | 2769.80 | 13606.20 |

As shown in [Table 9], when the lithium-to-phosphate (Li/PO₄) molar ratio was lower than the stoichiometric ratio (Li/PO₄ molar ratio: 3), the lithium ion recovery rate was observed to be over 90%. Considering the suppression of unreacted residual phosphate (PO₄) ions and lithium ion recovery efficiency, it is determined that a Li/PO₄ molar ratio in the range of 2.73 to 3.33 is the most suitable condition for lithium phosphate separation.

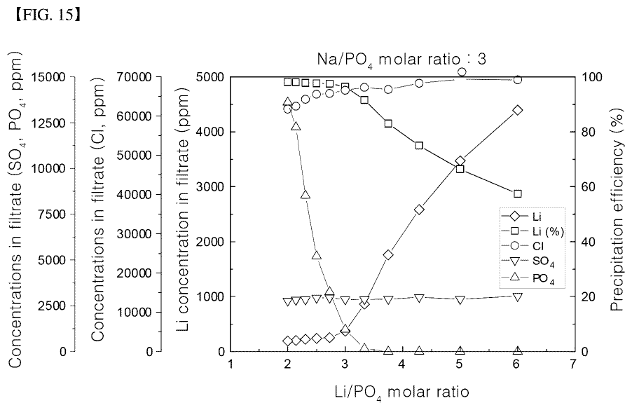

FIG. 15 is a graph illustrating the conversion rate of lithium phosphate and the distribution of ions in the filtrate according to the Li/PO₄ molar ratio, according to the exemplary embodiment 3-5.

Referring to FIG. 15, under the condition where the lithium-to-phosphate (Li/PO₄) molar ratio was set to 3 and then increased.

Here, it was confirmed that when the Li/PO₄ molar ratio exceeded 3.33, the conversion rate to lithium phosphate decreased.

### <Exemplary Embodiment 4> Purification of Residual Solution and Recovery of Lithium Component after Separation of Insoluble Lithium Compound

After separating the insoluble lithium compound using the same method as in FIG. 2, the residual solution was purified and the lithium component was recovered.

### <Exemplary Embodiment 4-1> Purification of Residual Solution after Separation of Insoluble Lithium Carbonate Compound

After performing the carbonation reaction for 8 hours at 60° C. by adding sodium carbonate (Na₂CO₃) under the condition of a lithium-to-carbonate (Li/CO₃) molar ratio of 1.67 to a lithium purification solution with a lithium ion concentration of 9890 ppm from Exemplary Embodiment 3-2, lithium carbonate was separated.

At this stage, in order to recover the lithium contained in the lithium carbonate conversion residual solution, separation was attempted in the form of either (1) lithium phosphate (Li₃PO₄) or (2) Li—Al LDH(LiAl₂(OH)₇2H₂O), both of which exhibit low solubility.

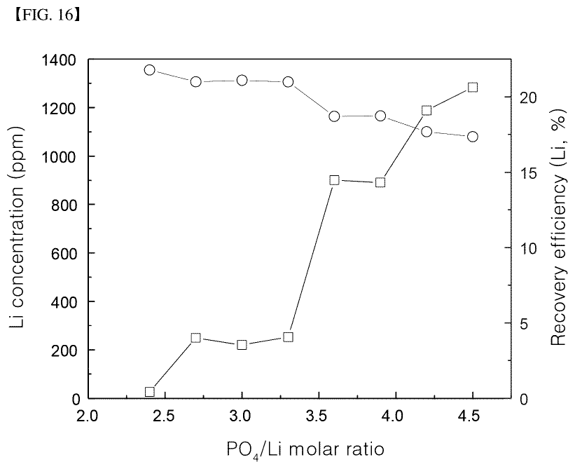

(1) The residual lithium concentration and recovery rate according to the phosphate-to-lithium (PO₄/Li) molar ratio during the conversion of the lithium (Li) component in the lithium carbonate conversion residual solution into lithium phosphate (Li₃PO₄) are shown in FIG. 16.

FIG. 16 is a graph illustrating the residual lithium concentration and recovery rate according to the phosphate/lithium (PO₄/Li) molar ratio during the conversion of lithium (Li) in the lithium carbonate conversion filtrate to lithium phosphate (Li₃PO₄), according to the exemplary embodiment 4-1.

As shown in FIG. 16, although the lithium recovery rate increases with an increasing phosphate-to-lithium (PO₄/Li) molar ratio, the reactivity was found to be very low.

Therefore, based on the results of FIG. 16, the conditions for converting the lithium contained in the lithium carbonate conversion residual solution into (2) Li—Al LDH (LiAl₂(OH)₇·2H₂O) were examined.

(2) To recover lithium contained in the lithium carbonate conversion residual solution, it was precipitated and separated as Li—Al LDH(LiAl₂(OH)₇2H₂O). In particular, 30 mL of the lithium carbonate conversion residual solution was reacted with sodium aluminate (NaAlO₂) as the precipitating agent at room temperature under a stirring speed of 300 rpm for 24 hours to recover the residual lithium in the solution.

When sodium aluminate (NaAlO₂) was added as the precipitant to the lithium carbonate conversion residual solution, the lithium concentration and conversion rate in the residual solution after lithium carbonate separation were analyzed according to the aluminum-to-lithium (Al/Li) molar ratio, as shown in [Table 10].

TABLE 10

| | Leachate | Reaction | | | | | | Li | | |
|---|---|---|---|---|---|---|---|---|---|---|
| | Volume | Temperature/ | Stirring | Al/Li | NaAlO₂ | | Li | Conversion | Na | Al |
| | Used | Time | Speed | Molar | Added | | conc. | Ratio | conc. | conc. |
| Condition | (mL) | (° C-h) | (RPM) | Ratio | (g) | pH | (ppm) | (%) | (ppm) | (ppm) |
| Li₂CO₃ | Purification_Initial | | | | | 9.09 | 1360.7 | | 45814.2 | |
| Production | 30 | Room temp.-24 | 300 | 1.00 | 0.872 | 11.95 | 726.1 | 46.6 | 62192.1 | 37.5 |
| Filtrate + | | | | 1.50 | 1.307 | 12.88 | 535.1 | 60.7 | 62435.7 | 291.7 |
| NaAlO₂ | | | | 2.00 | 1.743 | 13.13 | 225.0 | 83.5 | 64465.5 | 806.4 |
| | | | | 2.50 | 2.179 | 13.25 | 28.6 | 97.9 | 64475.1 | 1931.7 |
| | | | | 3.00 | 2.615 | 13.33 | 3.1 | 99.8 | 65697.8 | 4448.5 |
| | | | | 3.50 | 3.050 | 13.39 | N.D. | 100 | 66389.6 | 6705.9 |
| | | | | 4.00 | 3.486 | 13.44 | N.D. | 100 | 78490.0 | 8813.2 |
| | | | | 5.00 | 4.358 | 13.50 | N.D. | 100 | 81357.0 | 12317.6 |
| | | | | 6.00 | 5.229 | 13.56 | N.D. | 100 | 84002.3 | 15393.6 |
| | | | | 8.00 | 6.972 | 13.66 | N.D. | 100 | 88152.3 | 22527.9 |
| | | | | 10.00 | 8.715 | 13.76 | N.D. | 100 | 90666.9 | 26051.1 |
| | | | | 12.00 | 10.458 | 13.81 | N.D. | 100 | 107040.0 | 33381.9 |
| | | | | 14.00 | 12.201 | 13.84 | N.D. | 100 | 107612.4 | 40791.2 |
| | | | | 16.00 | 13.944 | 13.88 | N.D. | 100 | 108045.3 | 45401.5 |

A detailed review of [Table 10] confirms that over 99% of lithium was recovered when the aluminum-to-lithium (Al/Li) molar ratio was 3.

Accordingly, based on the results of Exemplary Embodiment 4-1, it is considered appropriate to use sodium aluminate (NaAlO₂) as the precipitant for lithium component separation from the lithium carbonate conversion filtrate.

### <Exemplary Embodiment 4-2> Removal of Phosphate (PO₄) Component from Filtrate after Precipitation of Insoluble Lithium Phosphate

After separating lithium phosphate under the condition of a Li/PO₄ molar ratio of 3 from Exemplary Embodiment 3-5, sodium aluminate (NaAlO₂) having high reactivity was used to further recover the lithium component remaining in the filtrate.

During the lithium recovery process, the addition of sodium aluminate (NaAlO₂) may increase the pH of the solution, potentially leading to the reformation of lithium phosphate and resulting in lithium loss. Furthermore, the formation of aluminum phosphate (AlPO₄) could lead to excessive consumption of sodium aluminate (NaAlO₂), thus necessitating the removal of the phosphate (PO₄) component.

Therefore, calcium hydroxide (Ca(OH)₂) was added to remove the phosphate (PO₄) component from the filtrate. Specifically, Ca(OH)₂ was added to 30 mL of the filtrate obtained after the separation of lithium phosphate, and the solution was stirred at room temperature at 300 rpm for 24 hours to purify the filtrate.

As a result of the analysis of Exemplary Embodiment 4-2, the ionic concentrations contained in the lithium phosphate conversion filtrate after the purification reaction were analyzed according to the calcium/phosphate (Ca/PO₄) molar ratio and are shown in [Table 11].

TABLE 11

| | Leachate | Reaction | | | | | | | | | |
|---|---|---|---|---|---|---|---|---|---|---|---|
| | Volume | Temperature/ | Stirring | Ca/PO₄ | Ca(OH)₂ | Li | Na | Ca | Cl | SO₄ | PO₄ |
| | Used | Time | Speed | Molar | Added | conc. | conc. | conc. | conc. | conc. | conc. |
| Condition | (mL) | (° C-h) | (RPM) | Ratio | (g) | (ppm) | (ppm) | (ppm) | (ppm) | (ppm) | (ppm) |
| Filtrate after | | | | | | 410.14 | 37818.69 | N.D. | 67592.00 | 3751.60 | 1202.96 |
| conversion of | 30 | Room temp.-24 | 30 | 1.50 | 0.045 | 406.85 | 37675.69 | N.D. | 66956.00 | 3706.80 | 720.54 |
| lithium | 30 | Room temp.-24 | 30 | 1.88 | 0.056 | 408.30 | 37673.93 | N.D. | 66642.80 | 3717.20 | 398.12 |
| phosphate | 30 | Room temp.-24 | 30 | 2.25 | 0.068 | 403.01 | 37874.40 | N.D. | 66395.20 | 3686.80 | 274.25 |
| | 30 | Room temp.-24 | 30 | 2.63 | 0.079 | 403.17 | 37159.88 | N.D. | 66477.20 | 3710.80 | 111.37 |
| | 30 | Room temp.-24 | 30 | 3.00 | 0.090 | 408.53 | 37174.16 | N.D. | 66572.80 | 3712.80 | 19.76 |
| | 30 | Room temp.-24 | 30 | 3.38 | 0.101 | 406.36 | 37821.99 | N.D. | 66254.00 | 3267.60 | N.D. |
| | 30 | Room temp.-24 | 30 | 3.75 | 0.113 | 416.04 | 37121.54 | 3.17 | 66243.20 | 3262.80 | N.D. |
| | 30 | Room temp.-24 | 30 | 4.50 | 0.135 | 418.33 | 37159.23 | 42.14 | 66423.20 | 3069.20 | N.D |

Referring to [Table 11] in particular, it was confirmed that the phosphate (PO₄) component could be removed when the calcium/phosphate (Ca/PO₄) molar ratio was 3.38.

Accordingly, based on these results, the condition with a Ca/PO₄ molar ratio of 3.38 was applied in the following example.

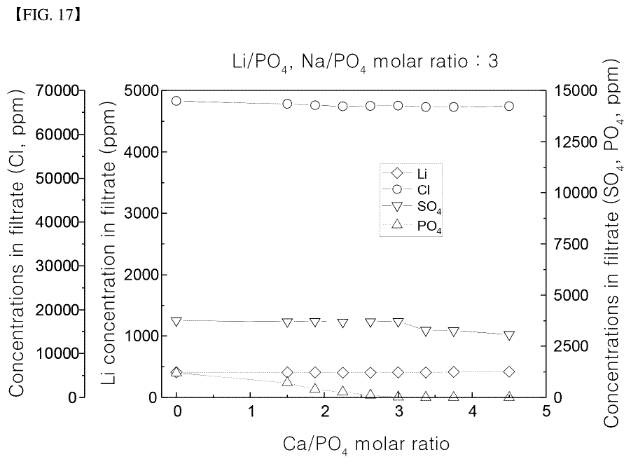

FIG. 17 is a graph illustrating the distribution of ions contained in the lithium phosphate conversion filtrate according to the amount of calcium hydroxide (Ca(OH)₂) added, according to the exemplary embodiment 4-2.

Referring to FIG. 17, it was confirmed that the concentration of phosphate (PO₄) in the filtrate after lithium phosphate separation decreased as the amount of calcium hydroxide (Ca(OH)₂) added increased.

### <Exemplary Embodiment 4-3> Recovery of Lithium Component after Lithium Phosphate Separation and Filtrate Purification

Following the separation of lithium phosphate under the condition of a lithium-to-phosphate (Li/PO₄) molar ratio of 3 as in Exemplary Embodiment 3-5, and the removal of phosphate (PO₄) components in the filtrate by adding calcium hydroxide (Ca(OH)₂) under a calcium-to-phosphate (Ca/PO₄) molar ratio of 3.38 as in Exemplary Embodiment 4-2, the lithium component contained in the filtrate was recovered by using sodium aluminate (NaAlO₂) as a precipitant. This was done to recover lithium in the form of a low-solubility Li—Al LDH(LiAl₂(OH)₇2H₂O).

In particular, 30 mL of the phosphate-removed filtrate was mixed with sodium aluminate (NaAlO₂), and the solution was stirred at room temperature at 300 rpm for 24 hours to purify the filtrate.

As a result of analyzing Exemplary Embodiment 4-3, the concentration of ions contained in the filtrate and the lithium recovery rate were determined according to the aluminum-to-lithium (Al/Li) molar ratio, and the results are shown in [Table 12].

TABLE 12

| | Leachate | Reaction | | | | | | Li | | |
|---|---|---|---|---|---|---|---|---|---|---|
| | Volume | Temperature/ | Stirring | Al/Li | NaAlO₂ | | Li | Conversion | Na | Al |
| | Used | Time | Speed | Molar | Added | | conc. | Ratio | conc. | conc. |
| Condition | (mL) | (° C-h) | (RPM) | Ratio | (g) | pH | (ppm) | (%) | (ppm) | (ppm) |
| Li₃PO₄ | Initial | | | | | 12.45 | 413.60 | | 36568.5 | — |
| Production | 30 | Room temp.-24 | 30 | 2.00 | 0.528 | 12.88 | 172.26 | 58.4 | 39017.8 | 1641.7 |
| Filtrate + | | | | 2.50 | 0.660 | 13.00 | 52.26 | 87.4 | 39747.6 | 1902.9 |
| NaAlO₂ | | | | 3.00 | 0.792 | 13.09 | N.D. | 100 | 41259.5 | 2490.5 |
| | | | | 3.50 | 0.924 | 13.16 | N.D. | 100 | 41784.2 | 3304.2 |
| | | | | 4.00 | 1.056 | 13.20 | N.D. | 100 | 42174.0 | 3989.3 |
| | | | | 5.00 | 1.320 | 13.26 | N.D. | 100 | 43485.2 | 5415.4 |
| | | | | 6.00 | 1.584 | 13.31 | N.D. | 100 | 43796.0 | 6872.7 |
| | | | | 8.00 | 2.112 | 13.34 | N.D. | 100 | 47373.4 | 6544.8 |
| | | | | 10.00 | 2.640 | 13.39 | N.D. | 100 | 49908.0 | 7538.4 |
| | | | | 12.00 | 3.168 | 13.44 | N.D. | 100 | 52074.7 | 7663.2 |
| | | | | 14.00 | 3.696 | 13.48 | N.D. | 100 | 54591.0 | 8192.9 |
| | | | | 16.00 | 4.224 | 13.54 | N.D. | 100 | 56631.1 | 9416.5 |

As shown in [Table 12], it was confirmed that under the condition where the aluminum-to-lithium (Al/Li) molar ratio was 3, more than 99% of the lithium component remaining in the filtrate was recovered.

### <Exemplary Embodiment 5> Conversion from Insoluble Lithium Compound Li-AI LDH to Lithium Solution for Lithium Phosphate Production

The conversion experiment from the insoluble lithium compound Li—Al LDH to a lithium solution for lithium phosphate production was performed by (1) alkaline roasting or (2) sulfuric acid roasting, using the same method as shown in FIG. 2.

Referring to Exemplary Embodiment 4-1, lithium carbonate was separated by adding sodium carbonate (Na₂CO₃) to a lithium purification solution (Li concentration: 9890 ppm) under conditions of a lithium/carbonate (Li/CO₃) molar ratio of 1.67, reacting at 60° C. for 8 hours. To recover the residual lithium component contained in the filtrate, the lithium component was separated as an insoluble lithium compound, Li—Al LDH(LiAl₂(OH)₇2H₂O), by adjusting the aluminum/lithium (Al/Li) molar ratio to 3.

(1) To recycle the separated Li—Al LDH(LiAl₂(OH)₇2H₂O) as a raw material for lithium phosphate production, it was converted into a lithium sulfate solution via salt roasting and water leaching, using sulfur-based compounds such as aluminum sulfate (Al₂(SO₄)₃), magnesium sulfate (MgSO₄), sodium sulfate (Na₂SO₄), and ammonium sulfate ((NH₄)₂SO₄).

In particular, 5 g of Li—Al LDH(LiAl₂(OH)₇2H₂O) was mixed with a sulfate compound to achieve a lithium/sulfate (Li/SO₄) molar ratio of 2, and subjected to salt roasting at various temperatures for 4 hours. The roasted product was then water-leached for 12 hours under a solid (product, g) to liquid (water, L) ratio of 100.

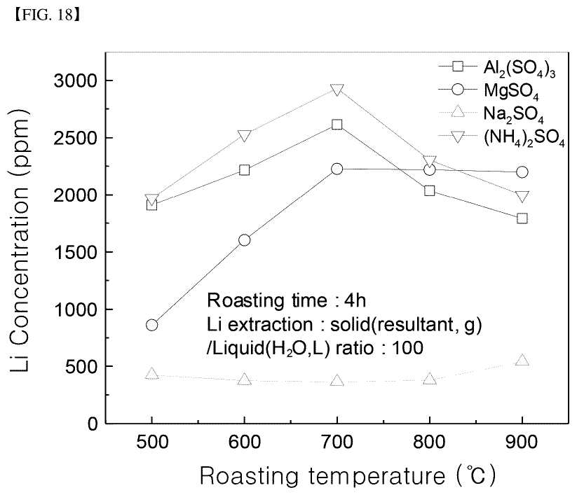

As a result of analyzing Exemplary Embodiment 5, the lithium ion concentration in the solution recovered after water leaching following salt roasting at each temperature was shown in FIG. 18.

FIG. 18 is a graph illustrating the lithium ion concentration in the recovered solution after water leaching, depending on the roasting temperature of Li—Al LDH(LiAl₂(OH)₇2H₂O) and sulfur compounds, according to the exemplary embodiment 5.

Referring to FIG. 18, in the case of aluminum sulfate (Al₂(SO₄)₃), magnesium sulfate (MgSO₄), and ammonium sulfate ((NH₄)₂SO₄) among the sulfate compounds, the lithium ion concentration in the solution after salt roasting at 700° C. for 4 hours and subsequent water leaching of the roasted product exceeded 2000 ppm. This lithium ion concentration level is sufficient to be reused as a raw material for lithium phosphate production.

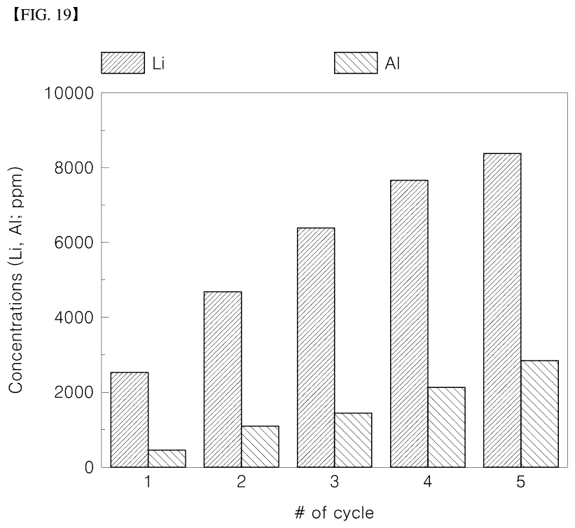

(2) To recycle the separated Li—Al LDH(LiAl₂(OH)₇2H₂O) as a raw material for lithium phosphate production, the Li—Al LDH(LiAl₂(OH)₇2H₂O) was subjected to a sulfuric acid reaction, followed by roasting at 300° C. for 1 hour. The resulting product was water-leached under a solid-to-liquid (product, g/water, L) ratio of 100. The leachate was filtered and reused, and the lithium ion concentration in the extractant was analyzed after each reuse cycle. The results are shown in FIG. 19.

FIG. 19 is a graph illustrating the lithium ion concentration in the extracted solution per extraction cycle, obtained by mixing Li—Al LDH(LiAl(OH)₇2H₂O) with sulfuric acid solution, roasting the mixture at 300° C. for 1 hour, performing water leaching under a condition of a solid (product, g)/liquid (water, L) ratio of 100, and recirculating the filtered solution, according to the exemplary embodiment 5.

Referring to FIG. 19, it was confirmed that when 3 M sulfuric acid solution was mixed with the Li—Al LDH(LiAl₂(OH)₇2H₂O) under a solid-to-liquid (S/L) ratio of 1000 and then subjected to sulfuric acid roasting, followed by water leaching at a solid-to-liquid ratio of 100, the lithium ion concentration in the recovered solution increased with each cycle of reuse.

Furthermore, it is considered feasible to produce a high-concentration lithium solution (>1%) that can be used not only for lithium phosphate production but also for lithium carbonate synthesis.

In the sulfuric acid roasting process, it is required that the sulfuric acid/lithium (SO₄/Li) molar ratio be in the range of 0.5 to 1.

When an excessive amount of sulfuric acid solution is added, it was found that aluminum as well as lithium is extracted in greater amounts.

Therefore, a sulfuric acid solution with a concentration of 2 M to 5 M is considered appropriate.

### <Exemplary Embodiment 6> Conversion from Lithium Carbonate to Lithium Chloride and Preparation of Lithium Chloride Powder

The conversion from lithium carbonate to lithium chloride and the preparation of lithium chloride powder were carried out using the same method as shown in FIG. 2.

### <Exemplary Embodiment 6-1> Thermodynamic Analysis of the Lithium Chloride Conversion Reaction

To analyze the reactivity of the lithium chloride conversion reaction of the lithium carbonate separated in Exemplary Embodiment 3-1, hydrochloric acid (HCl) and calcium chloride (CaCl₂)) were used to carry out the chlorination reaction of lithium carbonate.

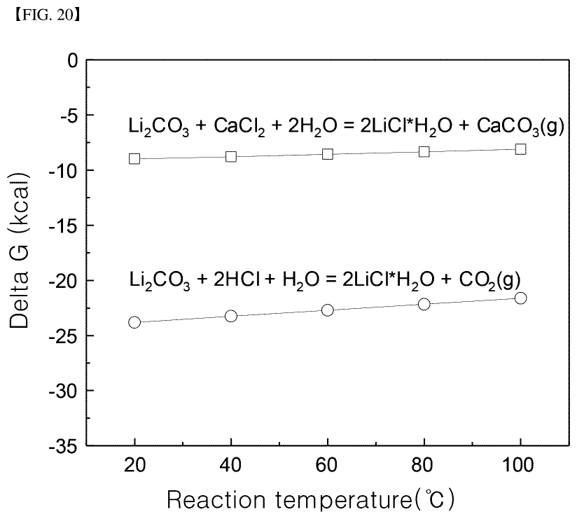

The lithium carbonate to lithium chloride conversion was thermodynamically analyzed by performing both an acid leaching reaction using hydrochloric acid and a slurry reaction using calcium chloride solution. The delta G analyses of each reaction equation were conducted to evaluate the thermodynamic feasibility of the lithium carbonate to lithium chloride conversion reaction, and the results are presented in FIG. 20.

FIG. 20 is a graph showing the thermodynamic analysis results of the conversion reaction from lithium carbonate to lithium chloride, according to the exemplary embodiment 6-1.

As shown in FIG. 20, when hydrochloric acid solution was used in the chlorination reaction, the conversion efficiency of lithium carbonate to lithium chloride was found to be higher than that observed when calcium chloride solution was used.

### <Exemplary Embodiment 6-2> Conversion from Lithium Carbonate to Lithium Chloride Solution Using Calcium Chloride (CaCl₂)) Solution

To convert the separated lithium carbonate into a lithium chloride solution, a calcium chloride (CaCl₂)) solution was mixed so that the molar ratio of lithium to chlorine (Li/Cl) was 1, and a slurry reaction was carried out at a reaction temperature of 20° C. for 8 hours.

As a result of analyzing Exemplary Embodiment 6-2, the lithium ion concentration in the filtrate after the slurry reaction was measured and is shown in [Table 13].

TABLE 13

| | | | | Solid- | Reaction | | Reaction Condition | |
|---|---|---|---|---|---|---|---|---|
| | | | Molar | Liquid | Temperature- | Stirring | (Li-compounds g/ | Li |
| | Exchange | Experimental | ratio | Ratio | Time | Speed | Ca-compounds g)/ | conc. |
| Li-source | Agent | Method | (Cl/Li) | (g/L) | (° C-hr) | (RPM) | H₂O mL | (ppm) |
| Li₂CO₃ | CaCl₂•2H₂O | Reflux | 1 | 100 | 20-8 | 300 | (10/20.302)/100 | 13235.45 |
| | | [CaCl₂ sol.] | | 200 | 20-8 | 300 | (20/40.604)/100 | 18521.12 |
| | | | | 300 | 20-8 | 300 | (30/60.905)/100 | 19137.72 |
| | | | | 300 | 80-8 | 300 | (30/60.905)/100 | 15426.52 |

Upon examining Table 13 in detail, it was confirmed that the lithium ion concentration tended to increase up to approximately 19,137 ppm as the solid-to-liquid ratio increased.

### <Exemplary Embodiment 6-3> Conversion of Lithium Carbonate to Lithium Chloride Powder Through HCl Leaching and Crystallization Method

A leaching reaction was carried out by mixing a hydrochloric acid (HCl) solution with the separated lithium carbonate such that the lithium-to-chlorine (Li/Cl) molar ratio was 1.

Specifically, 5.4 g of lithium carbonate powder was mixed with 100 mL of 0.144 M HCl, and the lithium carbonate was completely dissolved by stirring at 300 rpm.

Subsequently, the solution underwent a vacuum crystallization reaction at 80° C. for 24 hours.

After the 24-hour vacuum crystallization, powder was formed. However, moisture remained on the surface, thus the product was subjected to vacuum drying at room temperature for 8 hours, followed by drying at 200° C. for 1 hour under an inert atmosphere, and then the powder was recovered.

As a result of analyzing Exemplary Embodiment 6-3, the XRD pattern of the product under the crystallization and drying conditions of the solution was evaluated.

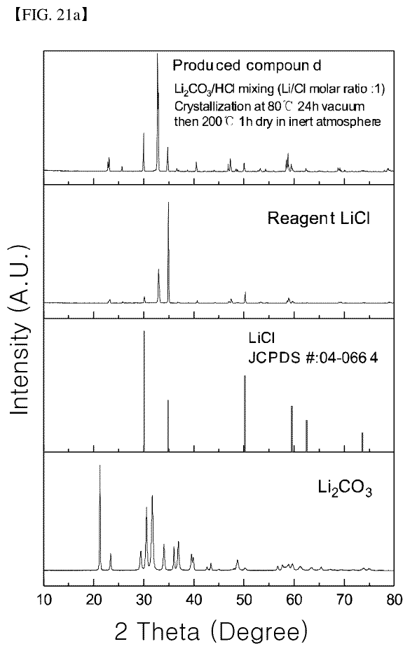

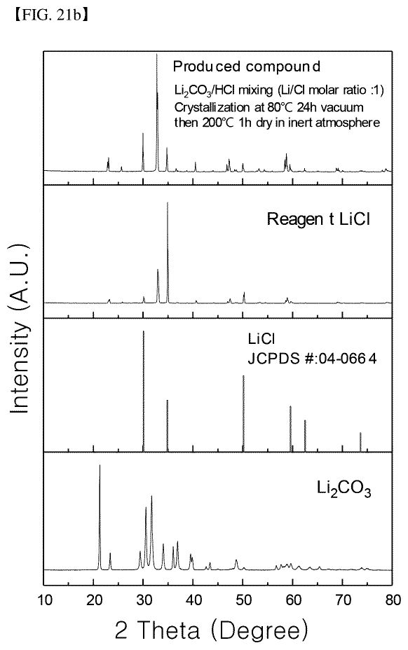

FIG. 21a is an XRD pattern of a product recovered after vacuum drying a hydrochloric acid leaching solution of lithium carbonate at 80° C. for 24 hours and subsequently drying it at 200° C. for 1 hour under an inert atmosphere, according to the exemplary embodiment 6-3.

FIG. 21b is an XRD pattern of a product recovered after vacuum drying a hydrochloric acid leaching solution of lithium carbonate for 8 hours, according to the exemplary embodiment 6-3.

Referring to FIGS. 21a to 21b, it was confirmed that lithium chloride (LiCl) powder was formed through comparison with a reagent-grade sample (KANTO CHEMICAL Co., LiCl, >98.2%).

### <Exemplary Embodiment 7> Conversion from Insoluble Lithium Compound Lithium Phosphate to Lithium Chloride and Preparation of Lithium Chloride Powder

The conversion from the insoluble lithium compound lithium phosphate to lithium chloride and the preparation of lithium chloride powder were carried out by the same method as illustrated in FIG. 2.

### <Exemplary Embodiment 7-1> Conversion from Lithium Phosphate to Lithium Chloride Powder via HCl Leaching and Crystallization Method

Lithium chloride powder was produced by mixing the separated lithium phosphate with hydrochloric acid (HCl) solution such that the molar ratio of lithium to chlorine (Li/Cl) becomes 1 to convert the separated lithium phosphate into lithium chloride/phosphate, followed by evaporating the phosphate.

10 g of lithium phosphate powder and 100 mL of 2.6 M hydrochloric acid (HCl) solution were mixed and stirred at 300 rpm until the lithium phosphate was completely dissolved.

Then, the resulting solution was subjected to vacuum crystallization at 80° C. for 12 hours.

The dried powder was subsequently placed in a box oven and dried at 200° C. for 3 hours before being collected.

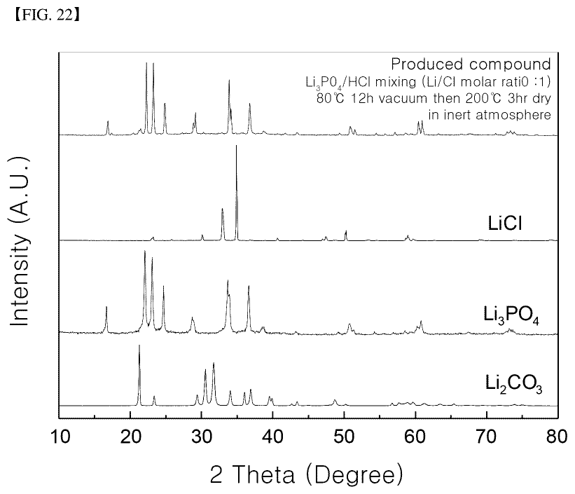

As a result of analyzing Exemplary Embodiment 7-1, the XRD pattern of the product under the crystallization and drying conditions of the solution was analyzed and is shown in FIG. 22.

FIG. 22 is an XRD pattern of a product recovered after drying a hydrochloric acid leaching solution of lithium phosphate at 200° C. for 3 hours under an inert atmosphere, according to the exemplary embodiment 7-1.

As shown in FIG. 22, the resulting product exhibited characteristics of lithium phosphate.

This can be understood by referring to the thermodynamic data in Table 14, which presents the effect of drying temperature on mixtures of lithium phosphate and hydrochloric acid.

TABLE 14

| | | | | | |
|---|---|---|---|---|---|
| Temp(° C.) | ΔH(kcal) | ΔS(cal/K) | ΔG(kcal) | K | Log(K) |

Li₃PO₄ + 3HCl = 3LiCl + H₃PO₄

| | | | | | |
|---|---|---|---|---|---|
| 0 | −31.502 | −90.320 | −6.832 | 2.927E+005 | 5.466 |
| 50 | −28.027 | −79.280 | −2.408 | 4.253E+001 | 1.629 |
| 100 | −27.116 | −76.666 | 1.492 | 1.337E−001 | −0.874 |
| 150 | −25.978 | −73.809 | 5.255 | 1.931E−003 | −2.714 |
| 200 | −24.617 | −70.775 | 8.870 | 7.991E−005 | −4.097 |

3LiCl + H₃PO₄ = Li₃PO₄ + 3HCl

| | | | | | |
|---|---|---|---|---|---|
| 0 | 31.502 | 90.320 | 6.832 | 3.416E−006 | −5.466 |
| 50 | 28.027 | 79.280 | 2.408 | 2.352E−002 | −1.629 |
| 100 | 27.116 | 76.666 | −1.492 | 7.480E+000 | 0.874 |
| 150 | 25.978 | 73.809 | −5.255 | 5.178E+002 | 2.714 |
| 200 | 24.617 | 70.775 | −8.870 | 1.251E+004 | 4.097 |

As shown in Table 14, during the drying process at 200° C., it is presumed that lithium phosphate remains due to the difference in boiling points between hydrochloric acid and phosphoric acid, as well as the difference in the stability of the resulting compounds, causing the hydrochloric acid to vaporize first.

To overcome this issue, a wet conversion method involving precipitation of phosphoric acid with a metal chloride is considered to be more efficient. This was investigated in the following Exemplary Embodiment 7-2.

### <Exemplary Embodiment 7-2> Wet Conversion from Lithium Phosphate to Lithium Chloride Solution

A wet conversion substitution reaction was performed by mixing the separated lithium phosphate with metal chlorides (AlCl₃, MgCl₂, CaCl₂)).

In this reaction, lithium phosphate and the metal chloride solution were mixed such that the molar ratio of lithium to chlorine (Li/Cl) became 1, and the mixture was stirred at 300 rpm at 80° C. for 8 hours to carry out the wet conversion substitution reaction.

As a result of analyzing Exemplary Embodiment 7-2, the concentration of lithium ions in the recovered lithium solution after the substitution reaction was analyzed and is shown in [Table 15].

TABLE 15

| | Condition | | | | Solid- | |
|---|---|---|---|---|---|---|
| | (Li₃PO₄ g/ | | Reaction | Reaction | Liquid | Li |
| | Chloride g)/ | | Temp. | Time | Ratio | conc. |
| | H₂O mL | Name | (° C.) | (h) | (g/L) | (ppm) |
| Li₃PO₄ + AlCl₃ | (10/11.516)/100 | Initial | 80 | 8 | 100 | — |
| (Li/Al molar ratio = 3/1) | | Final | | | | 16977.70 |
| Li₃PO₄ +MgCl₂ | (10/26.875)/100 | Initial | 80 | 8 | 100 | — |
| (Li/Mg molar ratio = 2/1) | | Final | | | | 11849.89 |
| Li₃PO₄ + CaCl₂ | (10/19.433)/100 | Initial | 80 | 8 | 100 | — |
| (Li/Ca molar ratio = 2/1) | | Final | | | | 16541.40 |

Upon closely examining [Table 15], it was confirmed that the lithium concentration in the recovered lithium solution was the highest when aluminum chloride (AlCl₃) and calcium chloride (CaCl₂)) solutions were used in the reaction.

Furthermore, analysis of the precipitates generated from the reaction revealed that the precipitates had a composition of Me-PO₄xH₂O (Me: Al, Mg, Ca), as shown in Equation 1.

$$2 {Li}_{3} {PO}_{4} + 3 Me - Cl + {H}_{2} O = 6 LiCl + Me - {PO}_{4} \times {H}_{2} O ( s ) ( Me : Al , Mg , Ca ) \qquad ( Equation 1 )$$

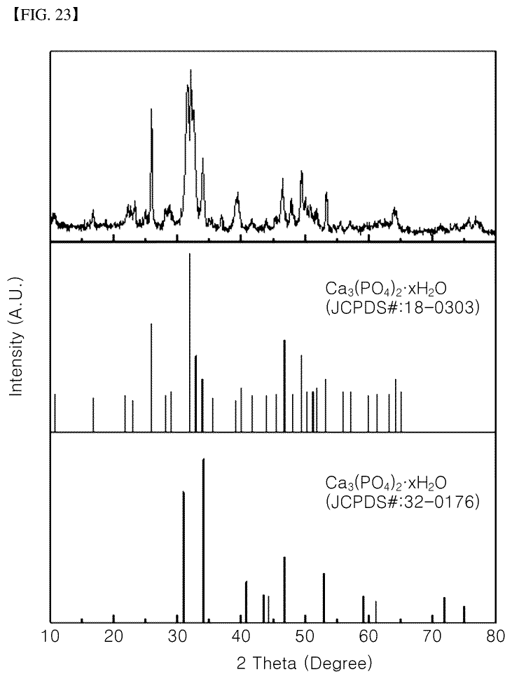

FIG. 23 is an XRD pattern of a by-product (precipitate) generated after a wet conversion reaction of lithium phosphate with a calcium chloride (CaCl₂)) solution, according to the exemplary embodiment 7-2.

Referring to FIG. 23, the precipitate was identified as Ca₃(PO₄)₂xH₂O, and as shown in Equation 1, it is considered that calcium phosphate hydrate is stably formed through a substitution reaction between lithium phosphate and calcium chloride.

### <Exemplary Embodiment 7-3> Purification of Filtrate after Separation of Precipitate by Wet Conversion Reaction of Lithium Phosphate and Calcium Chloride (CaCl₂)) Solution

After separating the precipitate formed by the wet conversion substitution reaction between lithium phosphate and calcium chloride (CaCl₂)) solution in Exemplary Embodiment 7-2, a precipitation method was used to remove calcium ions (Ca) contained in the filtrate.

More specifically, under the condition where the solid-to-liquid ratio of lithium phosphate to calcium chloride (CaCl₂)) solution was 100, the reaction was conducted at 80° C. for 4 hours with a stirring speed of 300 rpm. After separating the generated precipitate, the lithium and calcium ion concentrations in the filtrate were found to be 16,350 ppm and 1,031 ppm, respectively. The lithium conversion rate was 99% according to the calculation based on Equation 2.

$${I}_{Li} = ( \frac{{C}_{t} {V}_{t}}{{M}_{Li}} ) \times 100 \qquad ( Equation 2 )$$

$$( {M}_{L 1} : Lithium content in the used lithium phosphate ,$$

$${C}_{t} : Lithium ion cencentration in the filtrate ,$$

$${V}_{t} : Volume of the solution )$$

At this time, oxalic acid (HO₂C—CO₂H) was used to selectively precipitate calcium (Ca) ions contained in the recovered lithium chloride solution after separating the precipitate.

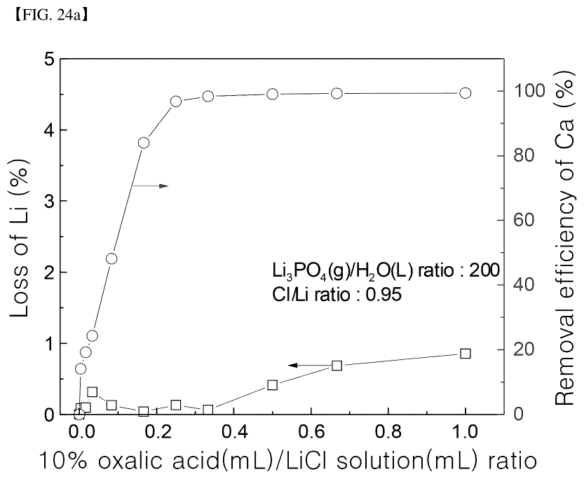

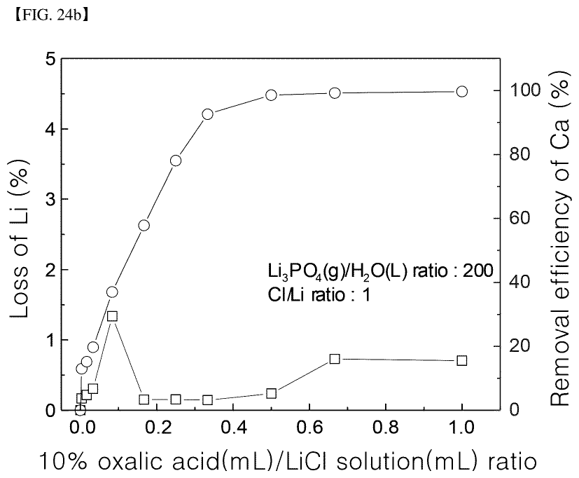

The resulting precipitate was calcium oxalate (CaC₂O₄), which has a very low solubility of 0.61 mg/100 mL H₂O, thereby exhibiting high efficiency in the calcium ion removal reaction, as further detailed in FIGS. 24a and 24b.

FIG. 24a is a graph showing changes in calcium ion content in the filtrate and lithium loss rate depending on the amount (mL) of 10% oxalic acid (HO₂C—CO₂H) added, based on 30 mL of lithium chloride solution recovered after preparing the lithium chloride solution and separating the precipitate under conditions of a Cl/Li molar ratio of 0.95 and a solid (Li₃PO₄)/liquid (H₂O) ratio of 200, according to the exemplary embodiment 7-3.

FIG. 24b is a graph showing changes in calcium ion content in the filtrate and lithium loss rate depending on the amount (mL) of 10% oxalic acid (HO₂C—CO₂H) added, based on 30 mL of lithium chloride solution recovered after preparing the lithium chloride solution and separating the precipitate under conditions of a Cl/Li molar ratio of 1 and a solid (Li₃PO₄)/liquid (H₂O) ratio of 200, according to the exemplary embodiment 7-3.

Upon closely examining FIGS. 24a and 24b, it was confirmed that the amount of residual calcium ions in the solution decreased as the added volume (mL) of 10% oxalic acid (HO₂C—CO₂H) increased.

In addition, based on 30 mL of the lithium chloride solution, it was confirmed that when the volume ratio of 10% oxalic acid to the lithium chloride (LiCl) solution was 0.25, approximately 99% of the calcium ions were removed.

Furthermore, the lithium loss in the solution was found to be less than 1%.

Therefore, based on the above results, the condition of a 0.25 volume ratio of 10% oxalic acid to lithium chloride (LiCl) solution was applied to the following exemplary embodiment.

### <Exemplary Embodiment 7-4> Production of Lithium Chloride Powder after Purification of Lithium Chloride Aqueous Solution from Lithium Phosphate

Lithium chloride powder was produced from the purified lithium chloride solution obtained in Exemplary Embodiment 7-3 by performing a crystallization reaction at 80° C. using vacuum distillation. The XRD pattern of the resulting product was analyzed.

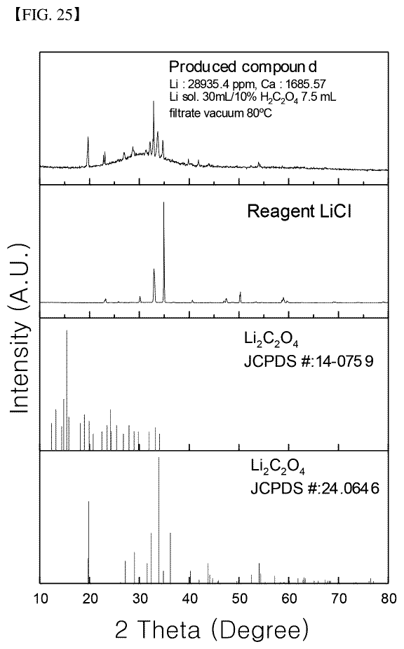

As a result of analyzing Exemplary Embodiment 7-4, the XRD pattern of the recovered product after vacuum distillation is shown in FIG. 25.

FIG. 25 is an X-ray diffraction (XRD) pattern of a product recovered after treating a lithium chloride solution with oxalic acid and vacuum drying the solution at 80° C., according to the exemplary embodiment 7-4.

As shown in FIG. 25, the recovered product after the crystallization reaction exhibited patterns of lithium chloride (LiCl) and lithium oxalate.

This is attributed to the boiling point of oxalic acid (365° C.) being higher than the boiling point (103° C.) of hydrogen chloride (H⁺/Cl⁻) present in the mixed composition, resulting in the residual presence of oxalic acid after crystallization.

### <Exemplary Embodiment 7-5> Wet Conversion Reaction from Lithium Phosphate to Lithium Chloride Solution

In accordance with Exemplary Embodiment 7-2, a wet conversion substitution reaction was performed using calcium chloride (CaCl₂)) as the metal chloride.

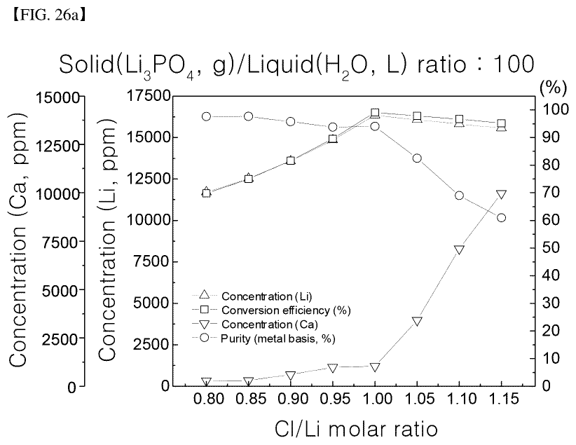

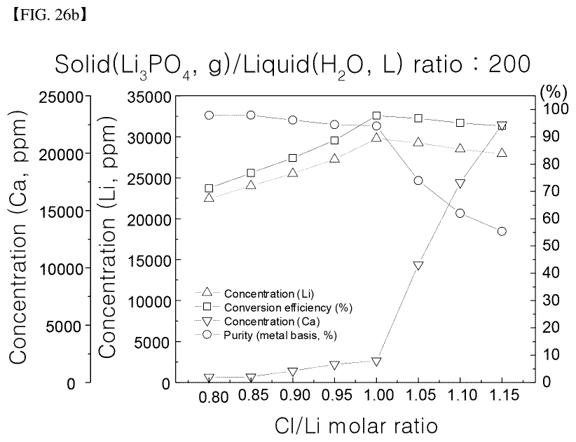

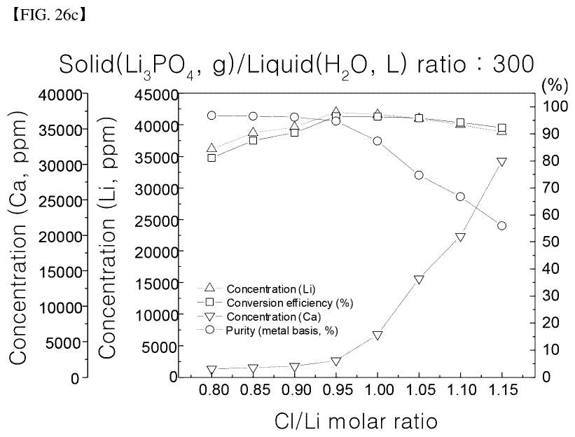

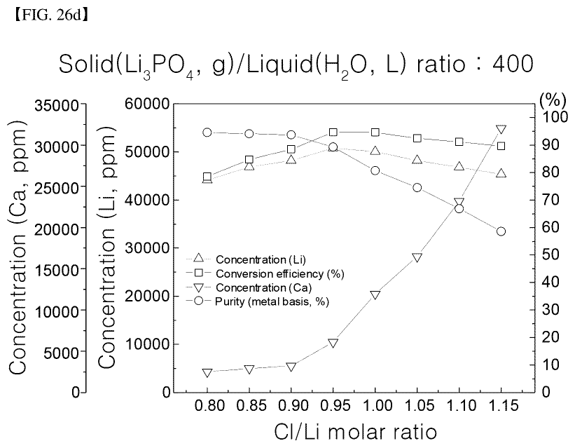

In this substitution reaction, the ion distribution in the resulting lithium chloride solution, lithium (Li) conversion yield, and the purity of the solution (based on metal ions) were analyzed according to the solid-to-liquid (Li₃PO₄ [g]/H₂O [L]) ratio and the molar ratio of chlorine to lithium (Cl/Li), and the results are shown in FIGS. 26a to 26d.

FIG. 26a is a graph showing the ion distribution, lithium (Li) conversion rate, and solution purity in the lithium chloride solution depending on the Cl/Li molar ratio, when the solid (Li₃PO₄, g)/liquid (H₂O, L) ratio is 100, according to the exemplary embodiment 7-5.

FIG. 26b is a graph showing the ion distribution, lithium (Li) conversion rate, and solution purity in the lithium chloride solution depending on the Cl/Li molar ratio, when the solid (Li₃PO₄, g)/liquid (H₂O, L) ratio is 200, according to the exemplary embodiment 7-5.

FIG. 26c is a graph showing the ion distribution, lithium (Li) conversion rate, and solution purity in the lithium chloride solution depending on the Cl/Li molar ratio, when the solid (Li₃PO₄, g)/liquid (H₂O, L) ratio is 300, according to the exemplary embodiment 7-5.

FIG. 26d is a graph showing the ion distribution, lithium (Li) conversion rate, and solution purity in the lithium chloride solution depending on the Cl/Li molar ratio, when the solid (Li₃PO₄, g)/liquid (H₂O, L) ratio is 400, according to the exemplary embodiment 7-5.

As shown in FIGS. 26a to 26d, when the solid-to-liquid ratio of lithium phosphate (Li₃PO₄, g) to water (H₂O, L) was 200 or lower, the lithium conversion yield was highest at a chlorine-to-lithium (Cl/Li) molar ratio of 1.

In contrast, when the solid-to-liquid ratio of lithium phosphate (Li₃PO₄, g) to water (H₂O, L) was 300 or higher, the lithium conversion yield was highest at a Cl/Li molar ratio of 0.95.

However, increasing the Cl/Li molar ratio to 1 or higher resulted in a rapid increase in the calcium (Ca) content remaining in the filtrate.

Additionally, analysis of the lithium and calcium contents in the filtrate after the reaction showed that the solution purity (based on cations) was approximately 95% under the conditions where the solid-to-liquid ratio of lithium phosphate (Li₃PO₄, g) to water (H₂O, L) was 300 or lower and the Cl/Li molar ratio was 0.9 or less.

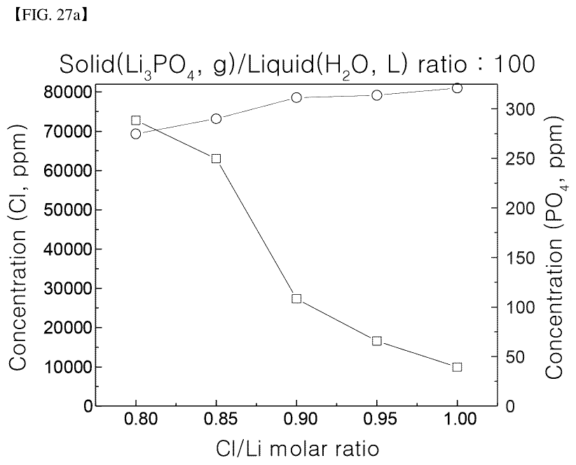

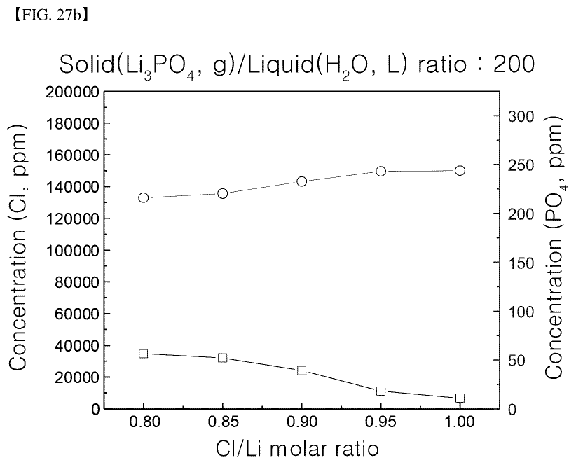

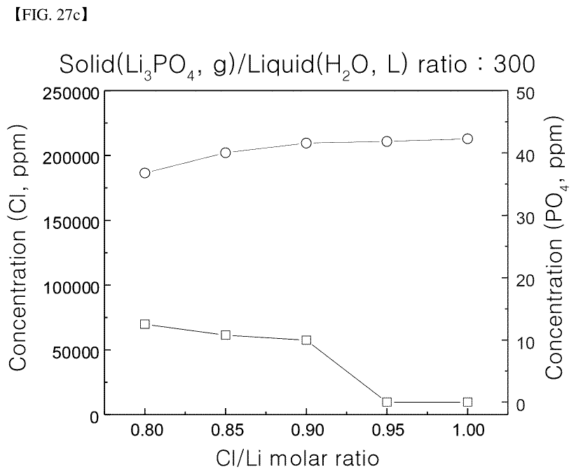

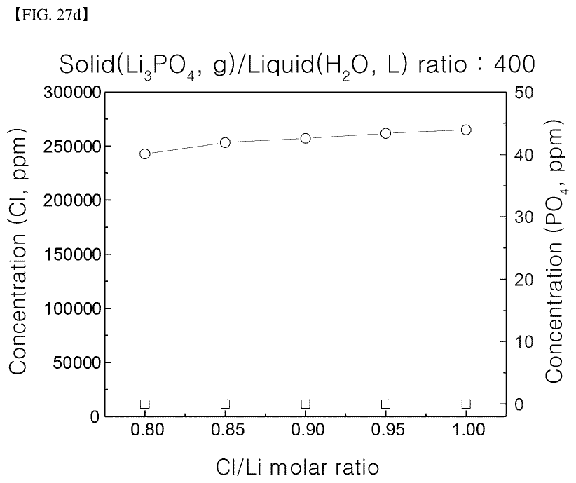

Furthermore, the distribution of anions contained in the lithium chloride solution according to the solid-to-liquid ratio of lithium phosphate (Li₃PO₄, g)/water (H₂O, L) and the Cl/Li molar ratio is shown in FIGS. 27a to 27d.

FIG. 27a is a graph showing the concentration of anions contained in a lithium chloride solution depending on the Cl/Li molar ratio, when the solid (Li₃PO₄, g)/liquid (H₂O, L) ratio is 100, according to the exemplary embodiment 7-5.

FIG. 27b is a graph showing the concentration of anions contained in a lithium chloride solution depending on the Cl/Li molar ratio, when the solid (Li₃PO₄, g)/liquid (H₂O, L) ratio is 200, according to the exemplary embodiment 7-5.

FIG. 27c is a graph showing the concentration of anions contained in a lithium chloride solution depending on the Cl/Li molar ratio, when the solid (Li₃PO₄, g)/liquid (H₂O, L) ratio is 300, according to the exemplary embodiment 7-5.

FIG. 27d is a graph showing the concentration of anions contained in a lithium chloride solution depending on the Cl/Li molar ratio, when the solid (Li₃PO₄, g)/liquid (H₂O, L) ratio is 400, according to the exemplary embodiment 7-5.

As shown in FIGS. 27a to 27d, it was confirmed that the phosphate (PO₄) ion content decreased as the solid-to-liquid ratio of lithium phosphate (Li₃PO₄, g) to water (H₂O, L) increased.

When the solid-to-liquid ratio of lithium phosphate (Li₃PO₄, g)/water (H₂O, L) was 200 or lower, it was confirmed that the phosphate (PO₄) ion content also decreased as the chlorine-to-lithium (Cl/Li) molar ratio increased.

In addition, when the solid-to-liquid ratio of lithium phosphate (Li₃PO₄, g)/water (H₂O, L) was 300, phosphate ions began to be removed starting from a Cl/Li molar ratio of 0.95.

Furthermore, when the solid-to-liquid ratio of lithium phosphate (Li₃PO₄, g)/water (H₂O, L) was 400, no phosphate ions were detected across the entire range of Cl/Li molar ratios.

Based on the analysis of Exemplary Embodiment 7-5, considering the concentrations of calcium (Ca) and phosphate (PO₄) ions in the filtrate and the conversion efficiency to lithium chloride, it was determined that suitable conditions for preparing lithium chloride solution are as follows: a solid-to-liquid ratio of lithium phosphate (Li₃PO₄, g)/water (H₂O, L) of 100 or 200 with a Cl/Li molar ratio of 0.9 to 1, and a solid-to-liquid ratio of 300 with a Cl/Li molar ratio of 0.8 to 0.95.

In addition, when the solid-to-liquid ratio of lithium phosphate (Li₃PO₄, g)/water (H₂O, L) exceeds 300, a significant increase in residual calcium ion content was observed.

### <Exemplary Embodiment 7-6> Recovery of Lithium Component from Byproduct after Conversion of Lithium Phosphate to Lithium Chloride Solution

It was confirmed that the byproduct (Ca₃(PO₄)₂xH₂O) generated in Exemplary Embodiment 7-2 has a high moisture content, resulting in a solution recovery loss of over 30%. To recover the residual lithium component from the byproduct (Ca₃(PO₄)₂xH₂O), a water leaching process was conducted under a solid (byproduct, g)/liquid (water, L) ratio of 100 at 80° C. with stirring at 300 rpm for 4 hours. The concentration of the recovered lithium component from the byproduct was analyzed and is presented in [Table 16].

TABLE 16

| | | | | | | Washing Conditions of Byproducts | | | | | |
|---|---|---|---|---|---|---|---|---|---|---|---|
| | | | | | | and Analysis Results | | | | | |
| Reflux Condition | | | | | | Washing | | Reaction | | | |
| | | | Solid- | Reaction | | Solid- | | Conditions | Reaction | | |
| | Metal | Cl/Li | Liquid | Temper- | Stirring | Liquid | Stirring | (Byproduct | Temper- | Li | |
| Li- | ion | Molar | Ratio | ature/ | Speed | Ratio | Speed | g/ | ature/ | conc. | |
| source | source | Ratio | (g/L) | Time | (RPM) | (g/L) | (RPM) | H₂O mL) | Time | (ppm) | Remarks |
| Li₃PO₄ | CaCl₂ | 1 | 100 | 80° C. 4 hr | 300 | 100 | 300 | (10/100) | 80° C. 4 hr | 2227.24 | After completion |
| | | | 200 | | | | | (10/100) | | 3073.83 | of the reflux |
| | | | 300 | | | | | (10/100) | | 3106.97 | reaction, dried at |
| | | | 400 | | | | | (10/100) | | 3260.30 | 80° C. in oven for |
| | | | | | | | | | | | 24 hrs. then wash |
| | | | | | | | | | | | with water |

As shown in Table 16, as the solid (lithium phosphate, g) to liquid (water, L) ratio increases, the preparation of high-concentration lithium solution becomes easier, but the moisture content also increases.

Based on these results, it was confirmed that, through a subsequent wet reaction (conversion of unreacted materials), lithium components remaining in the by-product (Ca₃(PO₄)₂xH₂O) can be recovered at a concentration that allows for recycling as a raw material for lithium phosphate production.

In addition, in Exemplary Embodiment 7-2, after the chlorine-to-lithium (Cl/Li) molar ratio was set to 0.95 and the reaction was carried out at 80° C. for 4 hours, the lithium chloride solution produced was separated, and the lithium components contained in the resulting by-product were subsequently recovered.

More specifically, in order to separate the residual lithium components, water leaching was conducted at a solid (by-product, g) to liquid (water, L) ratio of 100 for 4 hours while adjusting the temperature from 20° C. to 80° C.

The lithium concentrations recovered from the by-product at each washing temperature were analyzed and presented in [Table 17].

TABLE 17

| | | | | | | | | Washing Conditions | |
|---|---|---|---|---|---|---|---|---|---|
| | | | | | | | | of Byproducts and | |
| | | | | | | | | Analysis Results | |
| Reflux Condition | | | | | | | | Washing | |
| | | Solid- | | | Stir- | | | Solid- | Stir- |
| | Metal | Liquid | Cl/Li | Reaction | ring | Li | Ca | Liquid | ring |
| Li- | ion | Ratio | Molar | Temperature/ | Speed | conc. | conc. | Ratio | Speed |
| source | source | (g/L) | Ratio | Time | (RPM) | (ppm) | (ppm) | (g/L) | (RPM) |
| Li₃PO₄ | CaCl₂ | 200 | 0.95 | 80° C. 4 hr | 300 | 27449.59 | 1597.70 | 100 | 300 |

| Washing Conditions | | | | | |
|---|---|---|---|---|---|
| of Byproducts and | | | | | |
| Analysis Results | | | | | |
| Reaction | | | | | |
| Conditions | Reaction | Li | Ca | Cl | |
| (Byproduct | Temperature/ | conc. | conc. | conc. | |
| g/H₂O mL) | Time | (ppm) | (ppm) | (ppm) | Remarks |
| (10/100) | 20° C. 4 hr | 2012.90 | 7.72 | 11441.40 | After completion of the |
| (10/100) | 40° C. 4 hr | 2114.99 | N.D. | 12033.90 | reflux reaction, dried at |
| (10/100) | 60° C. 4 hr | 2162.97 | N.D. | 12349.20 | 80° C. in oven for |
| (10/100) | 80° C. 4 hr | 2228.30 | N.D. | 12749.70 | 24 hrs |

As shown in [Table 17], it was confirmed that as the reaction temperature increased, not only the residual lithium components but also additional unreacted materials underwent further wet conversion reactions, resulting in a slight increase in the concentration of recovered lithium components.

### <Exemplary Embodiment 7-7> Preparation of Lithium Chloride Powder via Crystallization after Wet Conversion of Lithium Phosphate to Lithium Chloride Solution

Lithium chloride powder was prepared from the lithium chloride solution recovered after the wet substitution reaction according to Exemplary Embodiment 7-5.

In this case, the wet substitution reaction was conducted under conditions in which the lithium (Li) conversion rate was greater than 95%, and the calcium (Ca) content in the lithium chloride solution was relatively low.

More specifically, lithium chloride solution was produced by reacting lithium phosphate and water at a solid-to-liquid (lithium phosphate, g/water, L) ratio of 200 and a lithium-to-chlorine (Li/Cl) molar ratio of 0.95, at a reaction temperature of 80° C. and a stirring speed of 300 rpm for 8 hours.

After the reaction, the concentrations of lithium and calcium ions in the separated filtrate were approximately 29,800 ppm and 1,890 ppm, respectively.

The lithium chloride solution was recovered and crystallized in a vacuum concentrator at 80° C. for 24 hours to produce a powder, and the XRD pattern of the powder was analyzed.

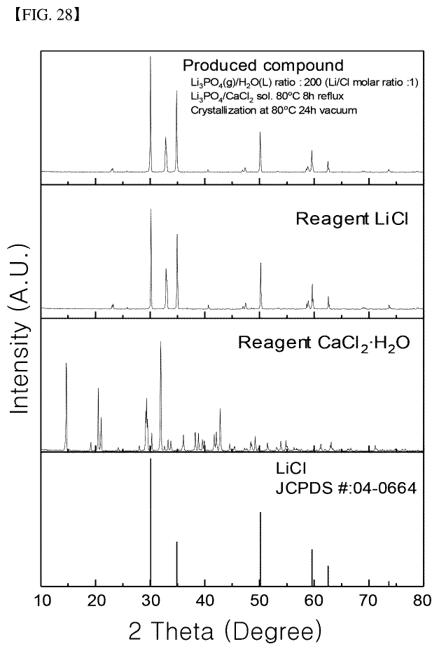

FIG. 28 is an X-ray diffraction (XRD) pattern of a powder recovered after vacuum drying a lithium chloride solution at 80° C. for 24 hours, according to the exemplary embodiment 7-7.

As shown in FIG. 28, the recovered powder exhibited a structure similar to the structure of reagent-grade lithium chloride (LiCl) powder (KANTO CHEMICAL Co., LiCl, >98.2%)

In the above, specific exemplary embodiments of the method for recovering lithium from leachate of waste primary lithium battery leachate and producing lithium chloride therefrom according to the present disclosure have been described. However, it will be apparent that various modifications can be made without departing from the scope of the present disclosure.

Therefore, the scope of the present disclosure should not be limited to the described exemplary embodiments, but should be defined by the following claims and their equivalents.

That is, the foregoing embodiments are illustrative in all aspects and not limiting, and the scope of the present disclosure should be indicated by the claims described below rather than the detailed description. All modifications and variations derived from the meaning, scope, and equivalent concepts of the claims should be construed as being included within the scope of the present disclosure.

### INDUSTRIAL APPLICABILITY

According to the present disclosure, a method for recovering lithium from a leachate of wasted primary lithium batteries is provided, enabling efficient separation of lithium contained at a concentration of 0.5% to 1% in the leachate. The method presents optimized conditions that suppress impurity incorporation, allowing the separated lithium to be recycled as a high-purity resource, thereby offering economic advantages.

1. A method for recovering lithium from waste primary lithium battery leachate and producing lithium chloride therefrom, comprising the steps of:
(1) preparing a lithium purification solution by separating impurities from a leachate of a waste primary lithium battery;
(2) separating an insoluble lithium compound from the lithium purification solution;
(3) converting the insoluble lithium compound into a lithium chloride solution; and
(4) producing lithium chloride powder from the lithium chloride solution;
wherein the impurities are separated from the leachate of the waste primary lithium battery by a pH adjustment method or a co-precipitation method;
wherein the insoluble lithium compound is lithium carbonate or lithium phosphate;
wherein the step of converting the insoluble lithium compound into a lithium chloride solution is performed by a wet conversion method;
wherein the recovered lithium chloride powder is crystalline;
wherein, a filtrate after the separating the lithium phosphate in step (2) undergoes a purification reaction to remove phosphate (PO₄) components; and
wherein, after the purification reaction, an additional precipitant is used to convert the filtrate into an insoluble compound, Li—Al-LDH(LiAl₂(OH)₇2H₂O), thereby recovering lithium at a yield of 99% or more.

2. The method of claim 1,
wherein, in step (1), the leachate of the waste primary lithium battery comprises at least one selected from the group consisting of lithium (Li), nickel (Ni), aluminum (Al), magnesium (Mg), calcium (Ca), cobalt (Co), manganese (Mn), silicon (Si), copper (Cu), vanadium (V), sodium (Na), potassium (K), chromium (Cr), iron (Fe), and zinc (Zn).

3. (canceled)

4. The method of claim 1,
wherein the pH adjustment method is performed using an alkaline solution,
the alkaline solution comprising at least one selected from the group consisting of sodium hydroxide (NaOH), potassium hydroxide (KOH), sodium carbonate (Na₂CO₃), sodium bicarbonate (NaHCO₃), potassium carbonate (K₂CO₃), and potassium bicarbonate (KHCO₃), and
wherein a range of the pH is from 3 to 11.

5. The method of claim 1,
wherein the co-precipitation method is performed using a co-precipitant,
wherein the co-precipitant is calcium oxide (CaO) or calcium hydroxide (Ca(OH)₂), and a molar ratio of metal ions in the co-precipitant to the impurities (Al+Cr+Fe) is from 0.5 to 2.

6. (canceled)

7. The method of claim 1,
wherein the lithium carbonate is obtained by a carbonation reaction,
wherein the carbonation reaction further includes a step of adjusting pH,
wherein a range of the pH is from 7 to 12,
wherein a molar ratio of lithium to carbonate (Li/CO₃) is from 1 to 2.5, and
wherein a temperature of the carbonation reaction is from 50° C. to 100° C.

8. The method of claim 1,
wherein the lithium phosphate is obtained by a precipitation method using a precipitant,
wherein the precipitant is at least one selected from the group consisting of phosphoric acid (H₃PO₄), sodium phosphate (Na₃PO₄), and ammonium phosphate ((NH₄)₂HPO₄),
wherein sodium hydroxide (NaOH) is mixed with the precipitant to adjust pH,
wherein a range of the pH is from 8 to 14,
wherein a molar ratio of lithium to phosphate (Li/PO₄) is from 2 to 6, and
wherein a molar ratio of sodium to phosphate (Na/PO₄) is from 2 to 5.

9. The method of claim 1, further comprising a step of removing phosphate (PO₄) ions by adding calcium oxide (CaO) or calcium hydroxide (Ca(OH)₂) to a filtrate after separating the lithium phosphate,
wherein a molar ratio of calcium to phosphate (Ca/PO₄) is from 1.5 to 4.5.

10. The method of claim 1,
wherein lithium is further recovered through an additional precipitation reaction from a filtrate after separating the lithium carbonate or the lithium phosphate,
wherein the lithium in the filtrate is converted into an insoluble compound, Li—Al-LDH (LiAl₂(OH)₇2H₂O), by using sodium aluminate (NaAlO₂) as an additional precipitant, and
wherein a molar ratio of aluminum to lithium (Al/Li) is from 1.5 to 5.

11. The method of claim 10,
wherein the insoluble compound Li—Al-LDH(LiAl₂(OH)₇2H₂O) is further subjected to a sulfuric acid roasting reaction or a salt roasting reaction followed by a water leaching reaction to produce a lithium sulfate solution,
wherein the lithium sulfate solution is a high-concentration lithium solution suitable for producing lithium phosphate or lithium carbonate.

12. The method of claim 11,
wherein in the sulfuric acid roasting reaction, sulfuric acid is added, subjected to roasting, and washed with water,
wherein a temperature of the sulfuric acid roasting reaction ranges from 250° C. to 350° C.,
wherein a sulfuric acid solution used for the sulfuric acid roasting reaction has a concentration ranging from 2 M to 5 M, and
wherein a lithium-enriched solution having a lithium concentration of 3000 ppm or higher is produced.

13. The method of claim 11,
wherein in the salt roasting reaction, sulfate is added and subjected to the salt roasting reaction,
wherein the sulfate used for the salt roasting reaction comprises at least one selected from the group consisting of aluminum sulfate (Al₂(SO₄)₃), magnesium sulfate (MgSO₄), sodium sulfate (Na₂SO₄), and ammonium sulfate ((NH₄)₂SO₄), and
wherein a temperature of the salt roasting reaction ranges from 500° C. to 900° C.

14. The method of claim 11,
wherein the water leaching reaction is performed from 1 to 5 times.

15. The method of claim 1,
wherein, in step (3), when the insoluble lithium compound is lithium carbonate,
a leaching or slurry reaction is performed using a chlorination reactant by a wet conversion method,
wherein the chlorination reactant is hydrochloric acid (HCl) or calcium chloride (CaCl₂)), and
wherein a solid-to-liquid ratio of the lithium carbonate to water ranges from 100 to 300.

16. The method of claim 1,
wherein, in step (3), when the insoluble lithium compound is lithium phosphate,
a substitution reaction of a metal chloride is performed by a wet conversion method,
wherein the metal chloride comprises at least one selected from the group consisting of magnesium chloride (MgCl₂), aluminum chloride (AlCl₃), and calcium chloride (CaCl₂)),
wherein a solid-to-liquid ratio of the lithium phosphate to water ranges from 100 to 400, and
wherein a molar ratio of chlorine to lithium (Cl/Li) ranges from 0.5 to 1.5.

17. The method of claim 16,
wherein a lithium chloride solution is formed by removing metal through an additional precipitation method from a filtrate after separating a precipitate generated by the substitution reaction, and
wherein oxalic acid is used in the additional precipitation method.

18. The method of claim 16,
wherein a water leaching reaction is further performed to separate lithium components contained in a precipitate generated by the substitution reaction,
wherein a temperature of the water leaching reaction ranges from 20° C. to 80° C., and
wherein a solid-to-liquid ratio of the precipitate to water ranges from 100 to 400.

19. The method of claim 1,
wherein, in step (4), the lithium chloride powder is produced by a crystallization method of the lithium chloride solution, and
wherein the crystallization method comprises at least one selected from the group consisting of vacuum drying and high-temperature drying under an inert atmosphere.
